(19) United States
(12) Patent Application Publication
(10) Pub. No.: US 2003/0086108 A1
(43) Pub. Date: May 8, 2003

(54) Printer certification system

(76) Inventor: Susan Barkis, Eagle, ID (US)

Correspondence Address: ROBERT L. SHAVER, DYKAS, SHAVER & NIPPER, LLP, P.O. BOX 877, BOISE, ID, 83701-0877, US

(21) Appl. No.: 10/288,698

(22) Filed: Nov. 5, 2002

Related U.S. Application Data
(60) Provisional application No. 60/338,947, filed on Nov. 5, 2001.

(51) Int. Cl. B41B 1/00; G06F 15/00

(52) U.S. Cl. 358/1.13

(57) ABSTRACT

The invention is a quantifiable audit and certification system that measures and predicts the final print quality that a printer will produce under production conditions. By evaluating and rating processes and variables in the package development and printing process, point values are assigned. The point values are based on known industry standards with measurements designated by graded ratings of a high performance printer to a low performance printer. The total final point value predicts their certification level.

### BACKGROUND OF THE INVENTION

### Field of Invention

This invention relates generally to a method of evaluating and certifying printing processes, and more particularly to a certification method for flexography that determines values by measurement of print and press variables and communication processes, then calculates and identifies the final print quality or match to the final art target, of a package printing company.

The printed image of a retail product package is a reflection of the product, the brand and the company. Packaging has the power to create a brand, strengthen it and maintain dominance in the marketplace. There are thousands of packages in a typical store. Consumers make as much as 70% of all purchase decisions in the store. For this reason, the package print quality or match to the target artwork must be the highest quality possible to deliver the strongest on-shelf impact.

The person responsible for purchasing the printed packaging is the package purchasing buyer of any particular consumer product company. Buyers typically do not have the knowledge or tools to evaluate print quality. Their purchasing decisions are made mostly by price and the basis of a printer's reputation. Without assessing the abilities and print quality of a printer the package print business can be distributed to many high-end and low-end quality printers at the same time. The results can be poor print quality, lack of shelf impact and lost sales and market failures. The highest degree of quality and consistency is necessary to produce packaging with consistent on-shelf appearance, but the buyer does not know how to ensure that the packaging he is buying will have such quality.

The printing process is complex and requires more than outlined processes and procedures. Print and Press Variables must be held within specification to deliver quality printing. This is accomplished with the adherence of clearly defined and agreed upon workflow processes, standards and specifications.

An audit resulting in a certification ranking which defines the final printed “demonstrated print quality” or match to the target artwork has never been created for package printing.

Consumer product companies need a printer certification system to evaluate and assess a supplier's printing output. Some buyers are requiring other forms of quality control certifications and registrations, such as American Institute of Baking (AIB), National Food Processors Association (NFPA) or International Organization for Standardization (ISO). These registration and certification programs do not ensure “demonstrated print capability” or match to the target artwork. They only provide assurance that processes and procedures are in place and manufacturing facilities deploy a safe environment. Many printers complete a certification or registration to satisfy their customer's requirements but do not implement the process into their workflow. Such certifications are faulty, because they show what the printer could do, not what the printer will do. This is because the certification or inspection does not include items related to actual procedures practiced in a production run. Instead they typically verify items that are present, or which can be used in production.

The present invention uniquely calculates the audit scores of a printer and defines the level of “demonstrated print quality” or match to the artwork target the printer will achieve in the final printing. Never before has a system been developed that correlates an audit with the actual outcome of printed results.

Significant technical advances in the printing industry require greater print control. In the past the printing process was considered an “artistic” form. The printing process is now a scientific and measurable one. Printers have not implemented systems and processes to manage print and press variables. Specifications and tolerances in the material manufacturing (final design artwork, color separations, printing plates, ink, etc) have been established for packaging by the supplier of the materials but print variables directly related to the printed results (ink density, dot gain, color-to-color registration) have not.

Without a certification system such as that of the present invention, it is impossible for the package buyer to be assured that a printer will meet the print quality that they require or expect. Currently package printers depend upon commercial printing (magazine advertisements, brochures, etc.) specifications, such as SWOP and from these make alterations for their specific requirements for different ink color, ink color printing press sequence and substrate (paperboard, recycled board, foils, plastic, etc.). These specifications are guidelines and do not have any form of certification tied to the printer's print quality.

Print specifications exist but do not have an audit or certification process that correlates the printer's adherence to variables with demonstrated print quality. Some of these standards include: GRACol (General Requirements for Applications in Commercial Offset Lithography); SNAP (Specifications for Newsprint Advertising Production); SWOP (Specifications for Web Offset Publications); GCA Standard 132-1997 (International Paper Roll and Package Label Specifications); DDAP (Digital Distribution and Advertising for Publications) and FTA FIRST (Flexographic Technical Association Flexographic Image Reproduction Specifications & Tolerances). These specifications are guidelines and it is left to each printer to follow them. Programs referred to as certifications are quality assurance programs and do not define the “demonstrated print quality”.

Package material certifications or registrations are used in the industry for plates and proofing materials. DuPont Cyrel® Packaging Division conducts a QA Tradeshop Partner program. This program audits and monitors prepress providers to ensure they are making the DuPont Cyrel® printing plates per DuPont's specifications. In conjunction with SWOP (Specifications for Web Offset Publications) proofing materials such as: Kodak Approval Digital Color Proofing System, DuPont Waterproof® Color Proofing System, and Imation Matchprint® have been approved under the SWOP Certified Proofing System. This certification is based on commercial printing (magazines, collateral materials) and is used in limited package printing situations. These certification systems are actually quality control processes for the specific material variable (i.e., plates, film, etc.) are for materials, which are only one part of the press and print variables associated with printing.

There are a number of printing processes or methods used in package printing. Lithography, Flexography, Gravure, Silk Screen and Digital printing are the main types of print methods. The majority of packaging materials are produced by Lithography, Flexography and Gravure. These processes vary in the mechanics of the press, substrate printed, the color reproduction quality and cost.

Lithography and Gravure have been recognized as the best print processes for packaging based on cost and quality. Flexography was and in some package buyer's mind still is, considered a crude form of printing. In the past it was called “rubber stamp” printing since the printing plate and the inking process was the same as the typical rubber stamps used in offices today. The print reproduction was inferior to the other processes due to the inks used, printing plates and the mechanics of the printing press.

In recent years Flexography has made significant technical advancements. All components of the flexographic process have been improved: color separations, printing plates, inks and presses. Today flexographic color reproduction rivals that of Lithography and Gravure, but remains unrecognized by package buyers. Since Flexography continues to be an emerging technology many printers have not kept up with the changes or they cannot assimilate the new techniques into their current work processes. Therefore they continue to deliver below average print quality, even though better results in Flexography is possible.

This invention can be used for the other printing processes as well as other processes in the package development processes. These include Prepress Providers (color separation developers) and Package Designers.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF INVENTION

This invention is an audit and certification process that measures the development processes and print performance of press and process variables. The audit results in a rating of the printer's capability to produce consistent, high quality printing. The rating criteria are a mix of printing process variables and print requirements. These process and print variables are weighted differently. If printers with a higher rating level are chosen to produce packaging for a particular Consumer Product Company, the package design and brand identity of the brand or package match to the artwork target will be maintained in the printing process of the first and subsequent production runs.

This invention directly correlates the audit findings and scores with the final print quality level: the certification levels. A system for this type of correlation has never been developed previous to the present invention. By evaluating components of a system that are related to production practices, the certification of the invention has a predictive quality the prior art systems do not have.

This invention provides a benchmark of a printer's printing ability status and their progress in the adherence to industry and the inventor's specifications. It identifies their areas of strength and areas for improvement in the package printing development process. Certification can provide a marketing advantage against their competition. It demonstrates a printer's commitment to quality and process improvement to their existing and potential new customers. The certification levels of the invention can also be used by a purchaser to specify the level of quality that a printer must achieve in order to perform work for the buyer.

Unlike first party audits conducted by employees, in this certification a third party conducts all audits and determines the certification level for the printer. The audit has been developed using industry standard specifications and those identified by the inventor as necessary elements for determining final printed print quality. This means that the quality of a printer's output will be directly related to his specification level. This is different than systems which verify that certain procedures and controls are in place, and the printer could produce a certain quality if the procedures are used. The certification system of the invention states that the product from a printer will be a certain quality, based on measured indicators of process quality.

The audit variables are based on measurement categories. Some of these may include: communications, project team effectiveness and management commitment, incoming inspection of materials, print and process variables, production print preparation and standardization, print production controls and measurement, pressroom practices, press assistance and direction and technical advancements, innovations and on-going research and development. The weighted variables and the total point values determine the final rating level.

The point values in each measurement category are carefully designated to provide for a balanced packaging development activity. A printer could not reach the highest level by technical excellence alone. A balance of quality control systems, technical excellence and the partnering with customers is necessary to achieve the higher levels of the certification ranking.

This invention will also drive unnecessary costs from a printer's process, reduce lead-times, creating a faster speed to market for the consumer product company, resulting in increased sales and identify internal and external cost efficiencies. With more efficient and accurate press materials, measurement of the printing process and defined procedures for all systems the final printing will be an accurate print reproduction of the target artwork.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE FIGURES

FIG. 1 is the relationship between the Consumer Product Company Purchasing Buyer and the printers and the outcome using different printers with varying print quality.

FIG. 2 lists the measurement categories within the audit program.

FIG. 3 lists the segments within the first measurement category for Communication, Group Dynamics and Management Focus.

FIG. 4 lists the segments within the second measurement category for Incoming Inspection of Materials.

FIG. 5 lists the segments within the third measurement category for Print and Press Variables.

FIG. 6 lists the segments within the fourth measurement category for Production Print Preparation and Standardization.

FIG. 7 lists the segments within the fifth measurement category for Print Production Controls and Measurement.

FIG. 8 lists the segments within the sixth measurement category for Pressroom Practices.

FIG. 9 lists the segments within the seventh measurement category for Press Assistance and Direction.

FIG. 10 lists the segments within the eighth measurement category for Technical Advances, Innovations and On-Going R&D.

FIG. 11 lists the point values and level designations certification.

FIG. 12 lists the requirements and the point values assigned for parts of the Communications, Group Dynamics and Management Focus category.

FIG. 13 lists the requirements and the point values assigned for parts of the Communications, Group Dynamics and Management Focus category.

FIG. 14 lists the requirements and the point values assigned for parts of the Communications, Group Dynamics and Management Focus category.

FIG. 15 lists the requirements and the point values assigned for the remainder of the parts and final total point values for the Communications, Group Dynamics and Management Focus category.

FIG. 16 lists the requirements and the point values assigned for parts of the Incoming Inspection of Materials category.

FIG. 17 lists the requirements and the point values assigned for parts of the Incoming Inspection of Materials category.

FIG. 18 lists the requirements and the point values assigned for parts of the Incoming Inspection of Materials category.

FIG. 19 lists the requirements and the point values assigned for parts of the Incoming Inspection of Materials category.

FIG. 20 lists the requirements and the point values assigned for parts of the Incoming Inspection of Materials category.

FIG. 21 lists the requirements and the point values assigned for parts of the Incoming Inspection of Materials category.

FIG. 22 lists the requirements and the point values assigned for parts of the Incoming Inspection of Materials category.

FIG. 23 lists the requirements and the point values assigned for the remainder of the parts and final total point values for the Incoming Inspection of Materials category.

FIG. 24 lists the requirements and the point values assigned for parts of the Print and Press Variables category.

FIG. 25 lists the requirements and the point values assigned for parts of the Print and Press Variables category.

FIG. 26 lists the requirements and the point values assigned for parts of the Print and Press Variables category.

FIG. 27 lists the requirements and the point values assigned for the remainder of the parts and final total point values for the Print and Press Variables category.

FIG. 28 lists the requirements and the point values assigned for parts of the Print and Press Variables category.

FIG. 29 lists the requirements and the point values assigned for parts of the Print and Press Variables category.

FIG. 30 lists the requirements and the point values assigned for parts of the Print and Press Variables category.

FIG. 31 lists the requirements and the point values assigned for the remainder of the parts and final total point values for the Print and Press Variables category.

FIG. 32 lists the requirements and the point values assigned for parts of the Production Print Preparation and Standardization category.

FIG. 33 lists the requirements and the point values assigned for the remainder of the parts and final total point values for the Production Print Preparation and Standardization category.

FIG. 34 lists the requirements and the point values assigned for parts of the Production Print Preparation and Standardization category.

FIG. 35 lists the requirements and the point values assigned for parts of the Production Print Preparation and Standardization category.

FIG. 36 lists the requirements and the point values assigned for parts of the Production Print Preparation and Standardization category.

FIG. 37 lists the requirements and the point values assigned for the remainder of the parts and final total point values for the Production Print Preparation and Standardization category.

FIG. 38 lists the requirements and the point values assigned for parts of the Print Production Controls and Measurement category.

FIG. 39 lists the requirements and the point values assigned for parts of the Print Production Controls and Measurement category.

FIG. 40 lists the requirements and the point values assigned for the remainder of the parts and final total point values for the Print Production Controls and Measurement category.

FIG. 41 lists the requirements and the point values assigned for parts of the Print Production Controls and Measurement category.

FIG. 42 lists the requirements and the point values assigned for parts of the Print Production Controls and Measurement category.

FIG. 43 lists the requirements and the point values assigned for parts of the Print Production Controls and Measurement category.

FIG. 44 lists the requirements and the point values assigned for the remainder of the parts and final total point values for the Print Production Controls and Measurement category.

FIG. 45 lists the requirements and the point values assigned for parts of the Pressroom Practices category.

FIG. 46 lists the requirements and the point values assigned for parts of the Pressroom Practices category.

FIG. 47 lists the requirements and the point values assigned for the remainder of the parts and final total point values for the Pressroom Practices category.

FIG. 48 lists the requirements and the point values assigned for parts of the Pressroom Practices category.

FIG. 49 lists the requirements and the point values assigned for parts of the Pressroom Practices category.

FIG. 50 lists the requirements and the point values assigned for parts of the Pressroom Practices category.

FIG. 51 lists the requirements and the point values assigned for the remainder of the parts and final total point values for the Pressroom Practices category.

FIG. 52 lists the requirements and the point values assigned for parts of the Press Assistance and Direction category.

FIG. 53 lists the requirements and the point values assigned for the remainder of the parts and final total point values for the Press Assistance and Direction category.

FIG. 54 lists the requirements and total point values for the Technical Advancements, Innovations and On-Going R&D category.

### DESCRIPTION OF THE PREFERRED EMBODIMENT

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The certification levels are defined by the outcome of the audit. The Figures show how the variables of the printing process is divided into categories, subcategories, and individual quality criteria. The number values of the audit are specifically defined to arrive at the final print quality level delivered on press. The formula used is the total point values achieved resulting in the final certification level.

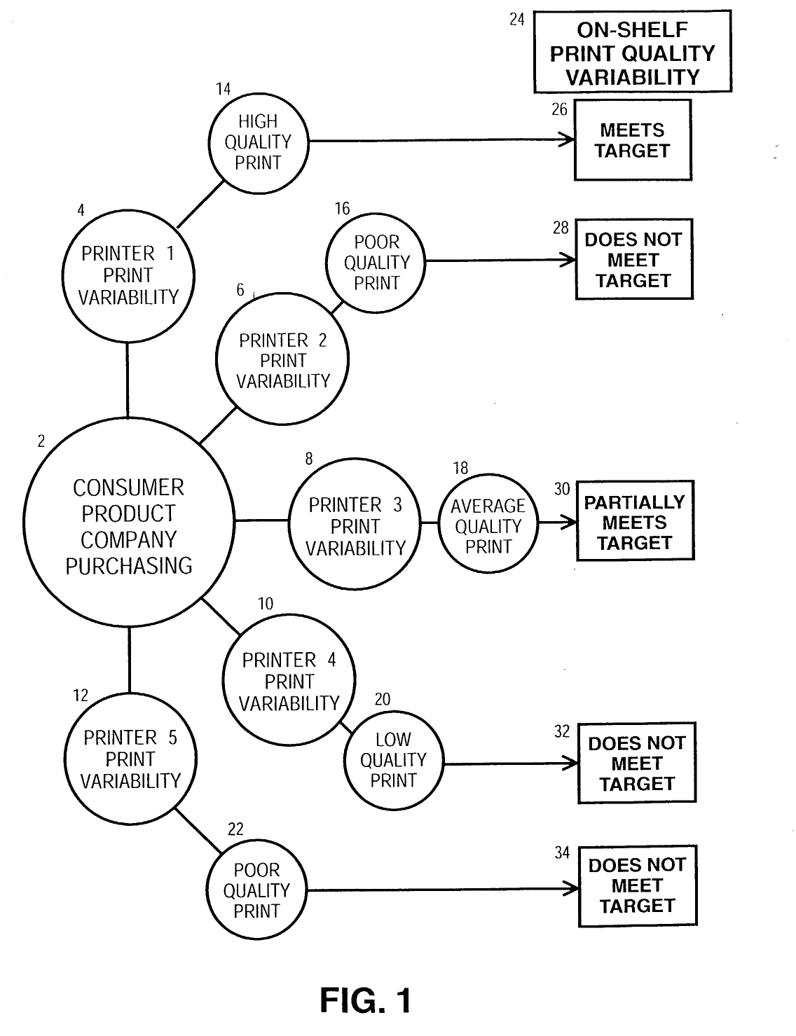

The preferred embodiment of the certification system of the invention is shown in FIGS. 1 though 54. FIG. 1 shows the typical process of awarding print jobs to various printers, all to produce a product package to be sold to consumers. Referring to FIG. 1 block 2, the Consumer Product Company Purchasing Buyer representative awards business to a number of printers with varying print quality shown in block 4, 6, 8, 10, and 12. The print quality and match to the original target artwork is described in the following blocks: block 14 indicates high quality print; block 16 indicates poor quality print; block 18 indicates average quality results; block 20 indicates low quality results and block 22 indicates poor quality results. The overall on-shelf print quality variability outcome, block 24 is defined in the following blocks: block 26 indicates a meets target, block 28 indicates a does not meet target, block 30 indicates partially meets target, block 32 indicates a does not meet target and block 34 indicates a does not meet target. Block 26, 28, 30, 32 and 34 display the print quality and variable matches to the desired color target that will appear on the store shelf. The results are a variety of print results and print quality, lack of shelf impact and lost sales and market failures. This example illustrates that the highest degree of quality and consistency is required to provide packaging with consistent on-shelf appearance and thus market success.

This audit and certification is predictive of the actual print quality that a printer will deliver. The certification level is a combination of the audit point values assigned to each category, subcategory and measurement criteria. For example, printers are graded on not only the understanding and use of processes and equipment but on the level of print quality achieved based on the measurable variables that have been classified for meeting variables that have been classified as high, medium and low level measurements. Prior art only validates the systems and tools of measurement are on-site and available to the employees to use, not that they are using them, achieving quality results or even exceeding basic standards.

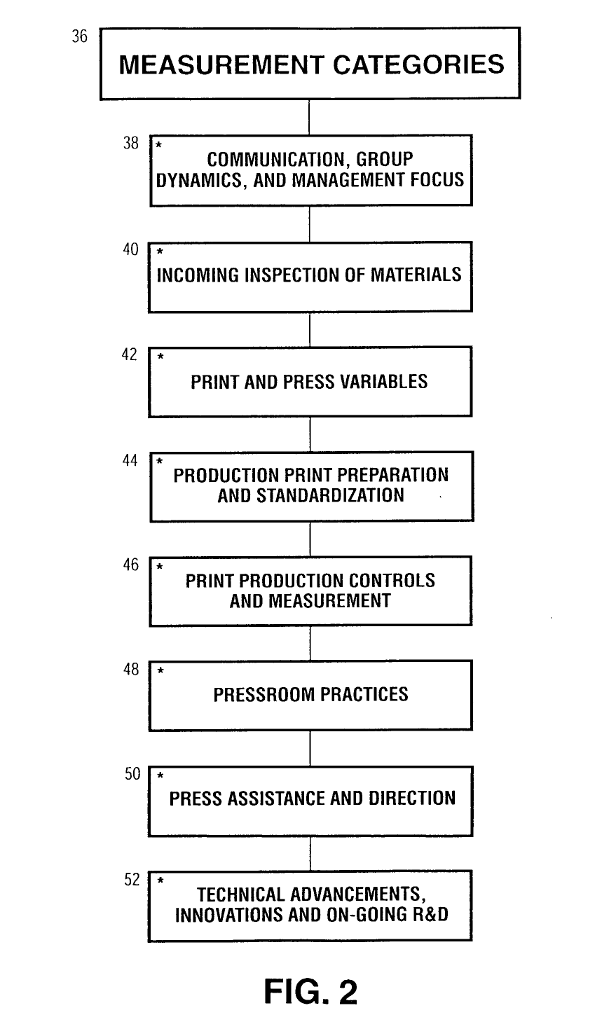

The audit preferred embodiment process and contents of the invention is divided into eight categories. These categories cover the specific print variables and processes and procedures named Measurement Categories, as shown in FIG. 2 block 36. The categories include block 38, Communications, Group Dynamics and Management Focus; block 40, Incoming Inspection of Materials; block 42, Print and Press Variables; block 44, Production Print Preparation and Standardization; block 46, Print Production Controls and Measurement; block 48 Pressroom Practices; block 50, Press Assistance and Direction and block 52, Technical Advancements, Innovations and On-Going R&D.

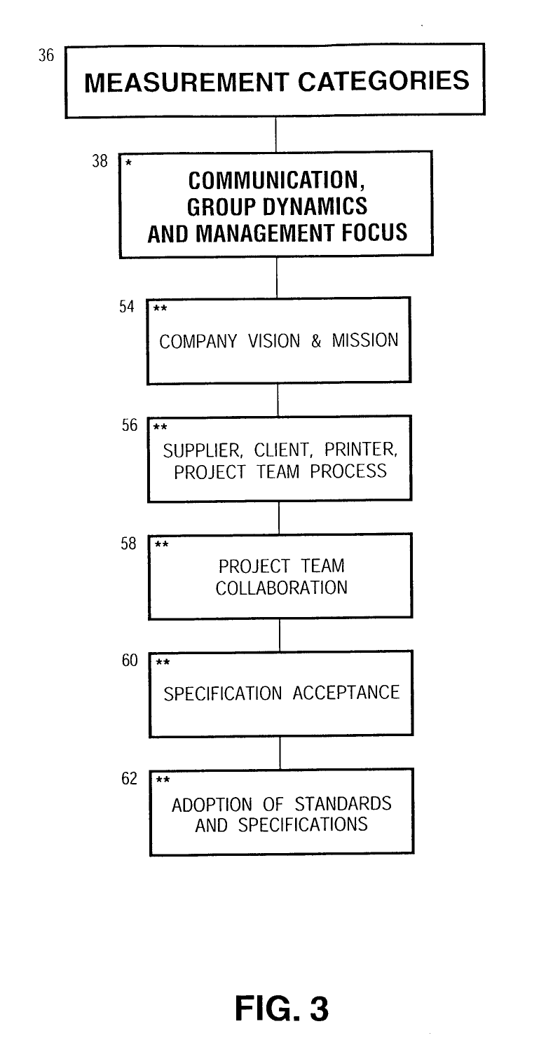

Referring to FIG. 3, under block 36 Measurement Category, block 38 Communication, Group Dynamics and Management Focus is defined to encompass subcategories block 54, Company Vision; block 56 Supplier, Client, Printer and the Process Team Process; block 58 the Project Team Collaboration; block 60 Specification Acceptance and block 62 Adoption of Standards and Specifications.

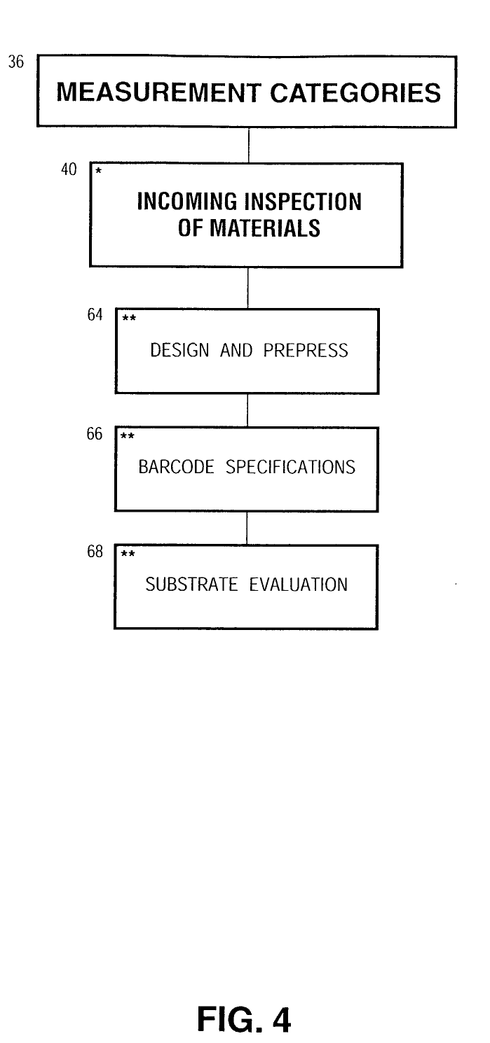

Referring to FIG. 4, under block 36 Measurement Category, block 40 Incoming Inspection of Materials is defined to encompass subcategories block 64 Design and Prepress; block 66 Barcode Specifications and block 68 Substrate Evaluation.

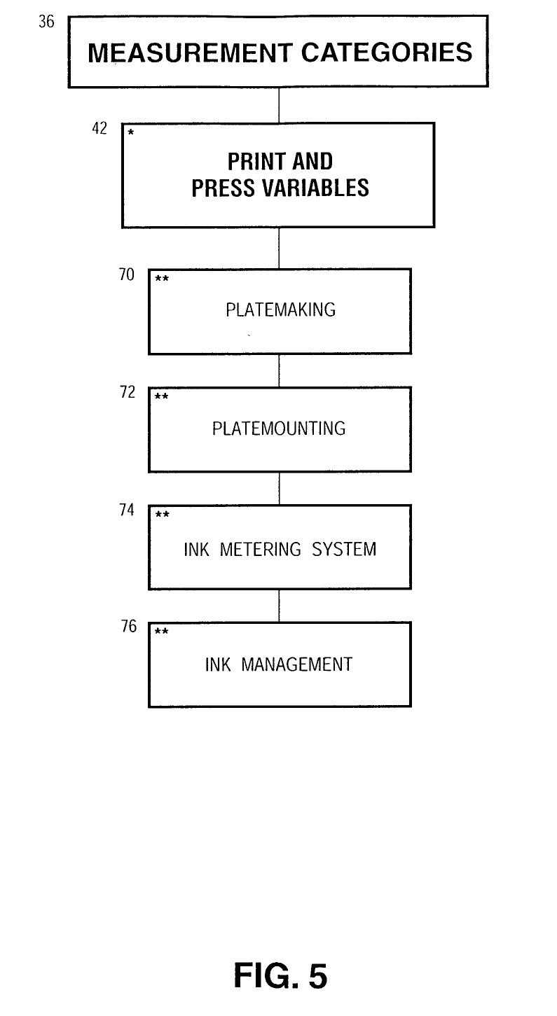

Referring to FIG. 5, under block 36 Measurement Category, block 42 Print and Press Variables is defined to encompass subcategories block 70 Platemaking; block 72 Platemounting; block 74 Ink Metering Systems and block 76 Ink Management.

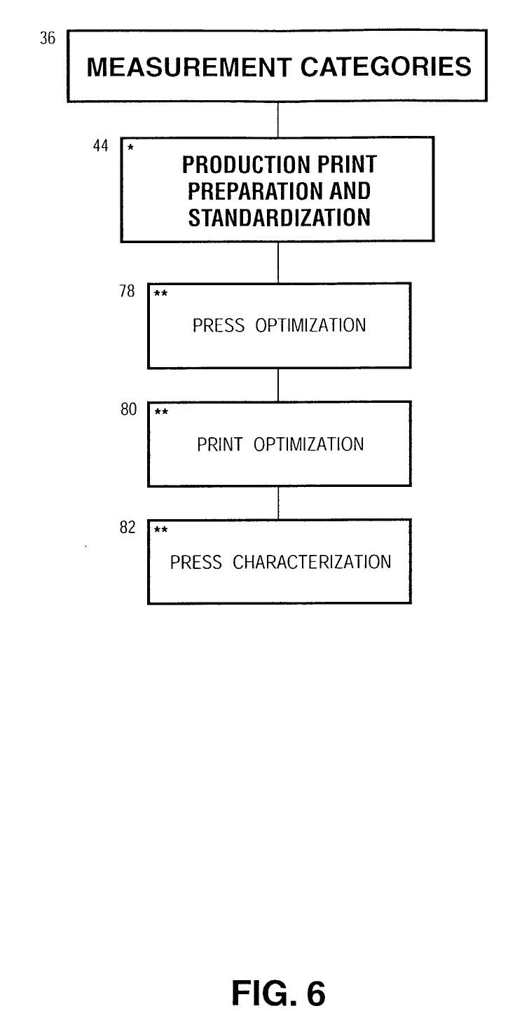

Referring to FIG. 6, under block 36 Measurement Category, block 44 Production Print Preparation and Standardization is defined to encompass subcategories block 78 Press Optimization; block 80 Print Optimization and block 82 Press Characterization.

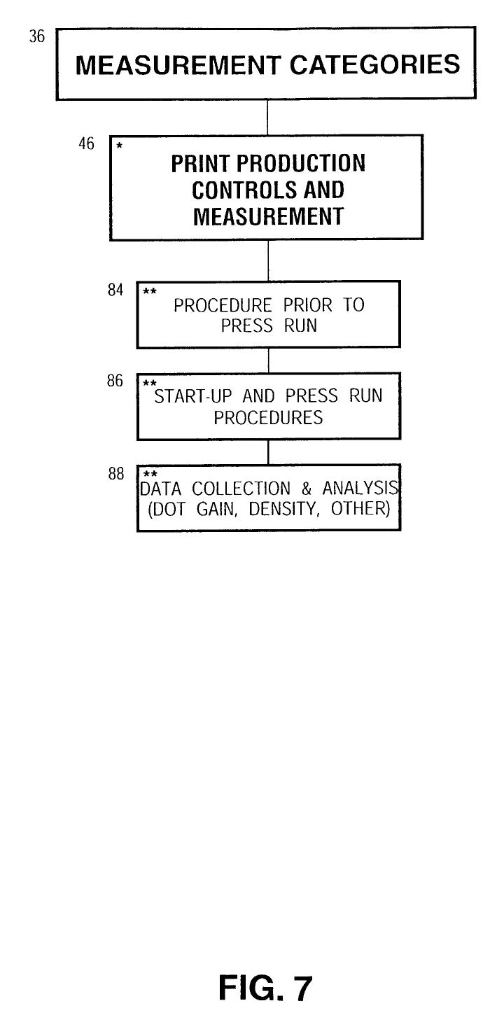

Referring to FIG. 7, under block 36 Measurement Category, block 46 Print Production Controls and Measurement is defined to encompass subcategories block 84 Procedure Prior to Press Run; block 86 Start-Up and Press Run Procedures and block 88 Data Collection & Analysis.

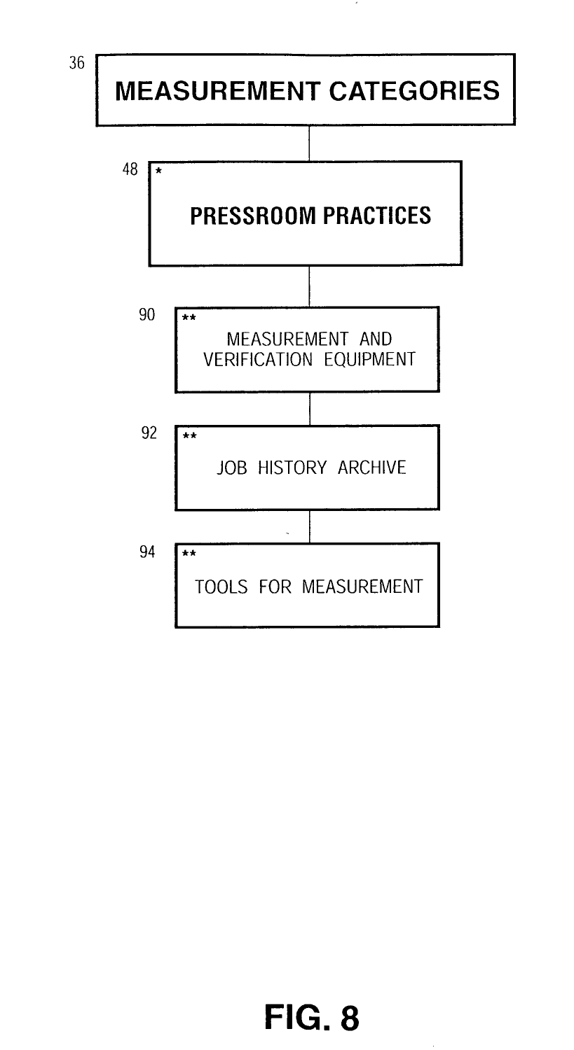

Referring to FIG. 8, under block 36 Measurement Category, block 48 Pressroom Practices is defined to encompass subcategories block 90 Measurement and Verification Equipment; block 92 Job History Archive and block 94 Tools for Measurement.

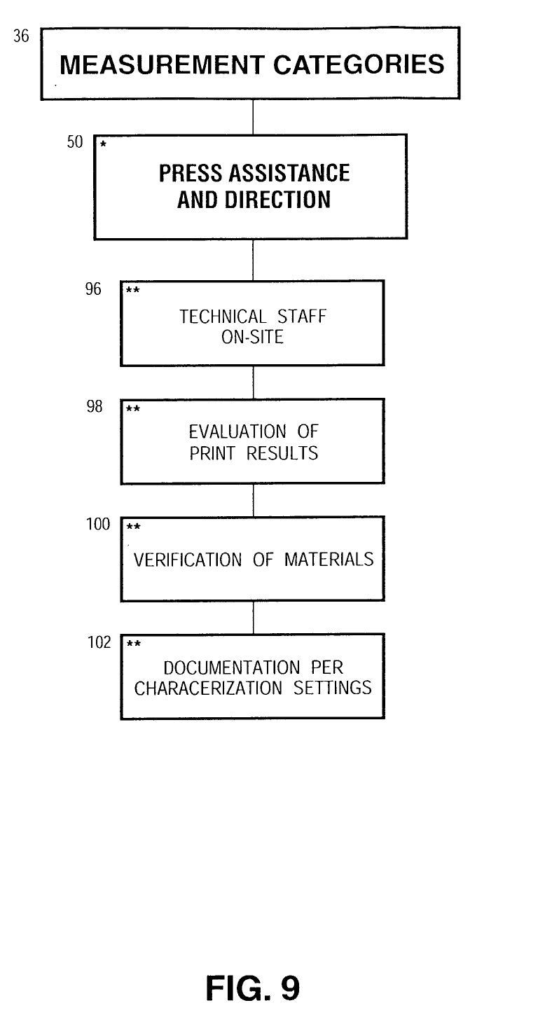

Referring to FIG. 9, under block 36 Measurement Category, block 50 Press Assistance and Direction is defined to encompass subcategories block 96 Technical Staff On-Site; block 98 Evaluation of Print Results; block 100 Verification of Materials and block 102 Documentation per Characterization Settings.

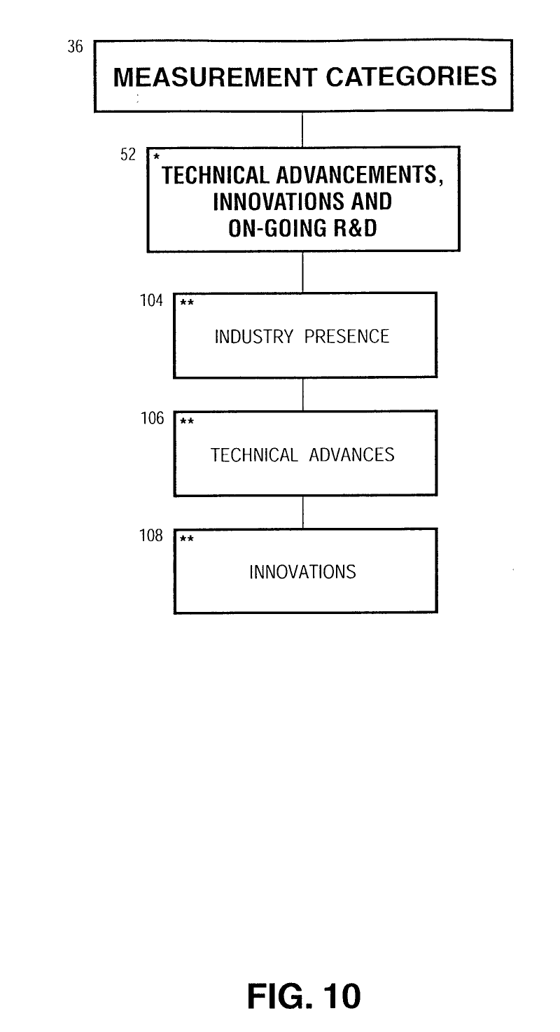

Referring to FIG. 10, under block 36 Measurement Category, block 52 Technical Advancements, Innovations and On-Going R&D is defined to encompass subcategories block 104 Industry Presence; block 106 Technical Advances and block 108 Innovations.

### Certification Levels

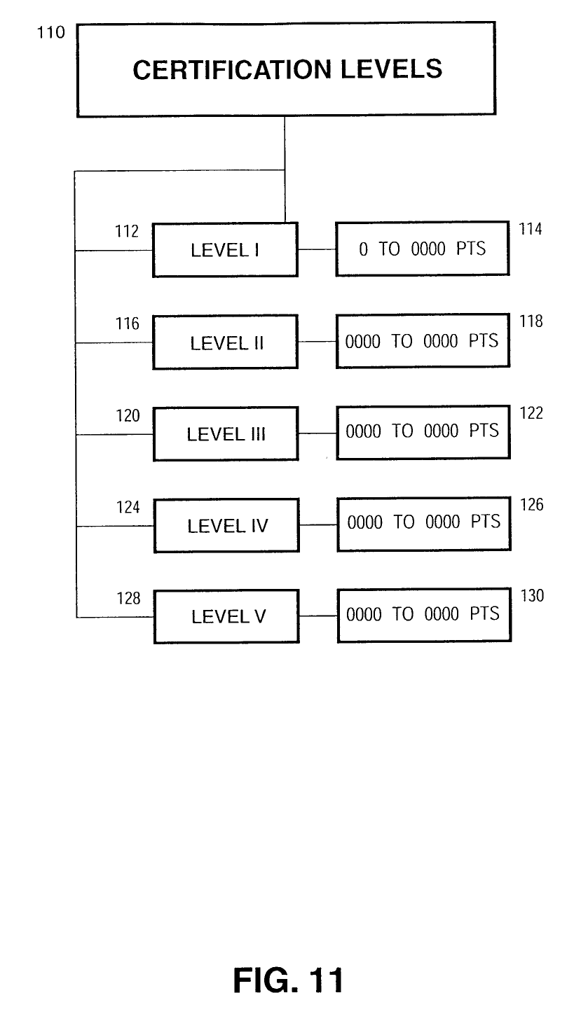

The results or the total point values awarded in the audit will result in the final Certification Level, FIG. 11, block 110. There are five levels of certification, each requiring a specific number of point values. The levels and point value requirements are defined as block 112 Level I, with total point requirement of block 114; block 116 Level II, with total point requirement of block 118; block 120 Level III, with total point requirement of block 122; block 124 Level IV, with total point requirement of block 126 and block 128 Level V, with total point requirement of block 130.

Block 112 Level I is described as a company that displays the following characteristics: Educational or training opportunities are defined. There are limited or no documented processes in place. There is acceptance of specifications and measurement by executive and plant management. They have established the beginning stages of specification implementation but may not be following any specifications. Block 114 is the point values required for this certification level.

Block 116 Level II is described as company that displays the following characteristics: Teams are assigned to identify company needs, plans and status. Some internal processes are identified. There are limited documented processes in place and they are running to specifications without total consistency. Block 118 is the point values required for this certification level.

Block 120 Level III is described as company that displays the following characteristics: There are functioning teams. Some documentation systems are in place. The primary processes are in place but are not fully integrated and the identification of specifications are in progress. Block 122 are the point values required for this certification level.

Block 124 Level IV is described as company that displays the following characteristics: The project team process is in place and functioning. The documentation systems are in progress. There are processes in place and they are running to specifications. Process control and production consistency in progress but may not be defined or consistent. Block 126 is the point values required for this certification level.

Block 128 Level V is described as company that displays the following characteristics: Processes and project team systems are in place with customers with total company (Executive Management and Sales) and plant integration. Documentation procedures are in place. They demonstrate long term process control, deploy consistent and repeatable results, exhibit leadership role with customers for standardization and measurement and is recognized an industry innovator. Block 130 is the point values required for this certification level.

Each category is described in more detail below.

### Communications, Group Dynamics and Management Focus

In the Figures, measurement categories are preceded by a star, measurement subcategories are preceded by two stars, and measurement criteria are preceded by three stars.

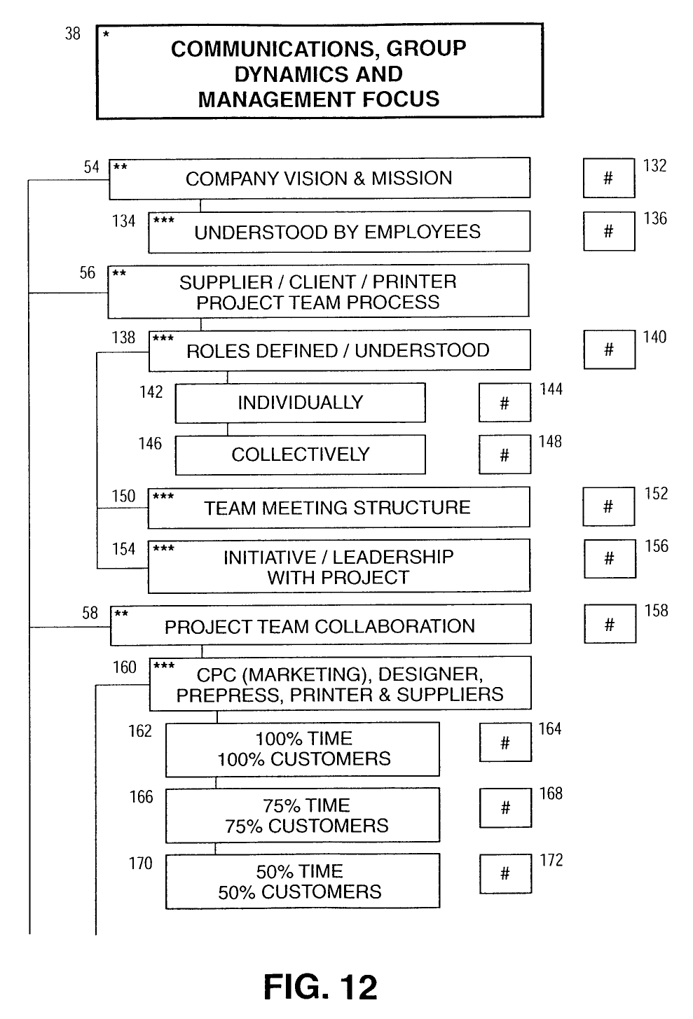

To meet the printer's customer's requirements and add value to the printed product and printing process, printers must be in control of all systems and processes. This requires that the systems and processes be identified, documented, measured and analyzed and combined into the total workflow. The Communications, Group Dynamics and Management Focus measurement category, block 38 is detailed in FIGS. 12, 13, 14 and 15. As listed in FIG. 12 the printing company must have a stated Company Vision and Mission, block 54 and these must both be understood and practiced by all employees, block 134. The Company Mission 54 is an example of a measurement subcategory, and the mission being understood by employees 136 is an example of a measurement criteria. In the Figures, measurement categories are preceded by a star, measurement subcategories are preceded by two stars, and measurement criteria are preceded by three stars. Executive management must direct and uphold these principles if the system is to work from the beginning to the end of the process workflow. Block 132 and 136 indicate the total number of point values assigned to this variable. The point valuation is not critical to the invention, and could be up to 100 points for each block for this level, for example. Each printer must participate and initiate participation in a project team, block 56. Each member's roles, for the project team must be defined and understood, block 138. Each individual must understand their role, block 142 and the group must understand the group role in the process, block 146. The sum of block 144 and 148 make up the total score in block 140. To function efficiently the team must have a structure, block 150 with point values shown in block 152.

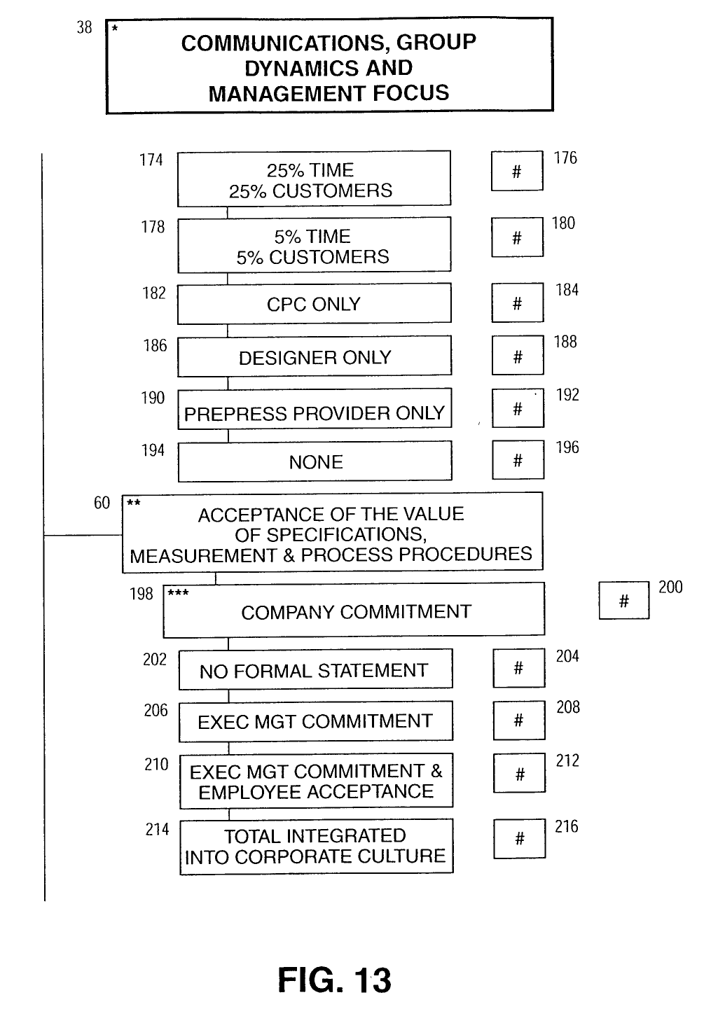

Partnering with the customer is a major element within the process of package development. The working relationship must be an open one. Each team member must understand all parts of the process and consider individual team member objectives. It is advantageous for the printer to provide leadership to ensure the team is established and functioning, block 154 with point values shown in block 156. There must be project team collaboration and customer involvement with internal clients and external clients and suppliers. All printer's employees must participate in collaboration, with other team members to ensure the process progresses effectively, block 58 with point values noted in block 158. The team must include members from the Consumer Packaging Company, the design firm, the prepress provider, the printer(s) and additional suppliers as identified in block 160. It is important for the printer to strive for this working relationship with all of their customers 100% of the time. FIG. 12, block 162, 166, FIG. 13, block 170, 174, 178, 182, 186, 190 and 194 describe the degree of involvement a printer may have with the team collaborative process. The weighted ratings for this measurement category are designated in FIG. 12, block 164, 168, 172, FIG. 13, block 176, 180, 184, 188, 192 and 196.

Documentation of standards and procedures are mandatory. Specifications must be established, measured and the data must be collected and reviewed. The work must follow these standards and specifications. Corrective action procedures must be in place to ensure compliance of all print and press variables. To be most effective in this part of the process there must be and acceptance and an understanding of the value of specifications, measurement and process procedures, block 60. There are varying levels of company commitment block 198. These levels are described in block 202, 206, 210 and 214. Block 204, 208, 212 and 216 are possible point values for company commitment, with a total score shown in block 200.

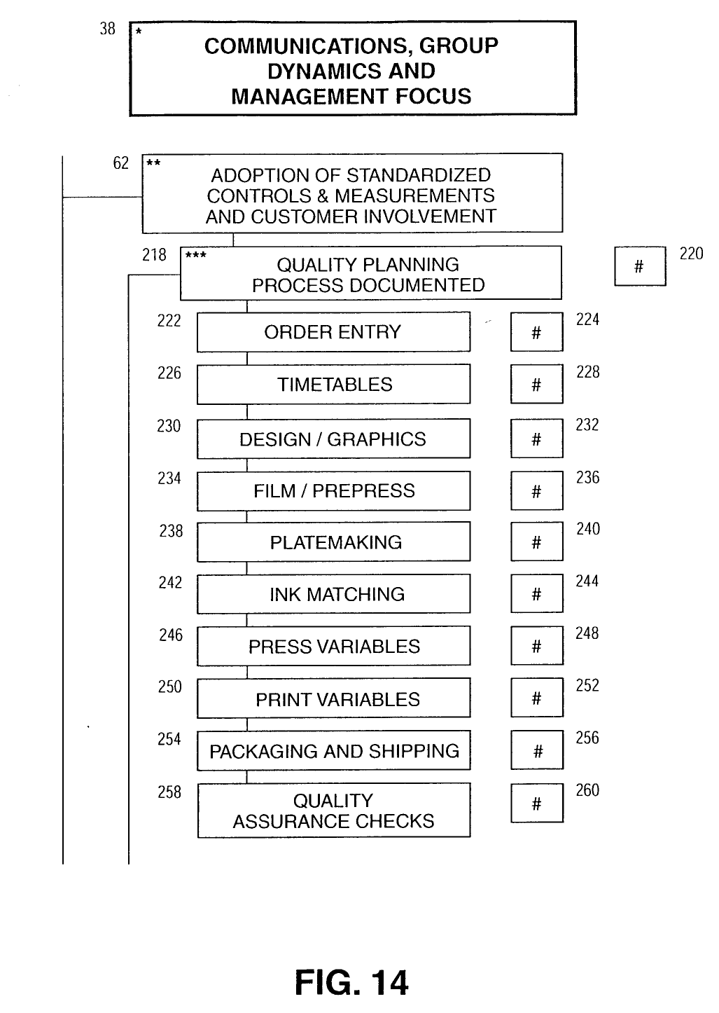

Systems must be established and be the basis for the entire workflow for a specific job order. A Quality Planning Process must establish the processes to follow, define, document and process the job. The printer must adopt standardized controls and measurement and work with their customers to tie these processes with the other team members, FIG. 14, block 62. There must be a quality process documented and in place, block 218. Some variables that may be included for measurement and documentation are shown in block 222, 226, 230, 234, 238, 242, 246, 250, 254 and 258. All elements of a job must be reviewed before moving to the next stage of production. These include Order Entry, block 222, when the design, specifications and order are received from the customer. There must timing set forth to meet the customer's timing requirements, block 226. The Design and Graphics, block 230 must be reviewed by all departments to ensure printability, pricing and materials required for the job. Film color separations and prepress (final films, proofs of the artwork and printing plates) must reviewed against the specifications, block 234, Printing Plates must be made to specifications and reviewed, Ink Matching must be completed and approved by the production department and the customer, block 242, Press Variables, the type of plates, ink system, etc, that ill be used, block 246 and Print Variables, substrate, ink colors, densities, etc., block 250, Packaging & Shipping, any specific packing and shipping requirements a customer may have, block 254 and Quality Assurance Checks, inspections for all processes, block 258. Block 220 is the total score achievable (the sum of block 224, 228, 232, 236, 240, 244, 248, 252, 256 and 260).

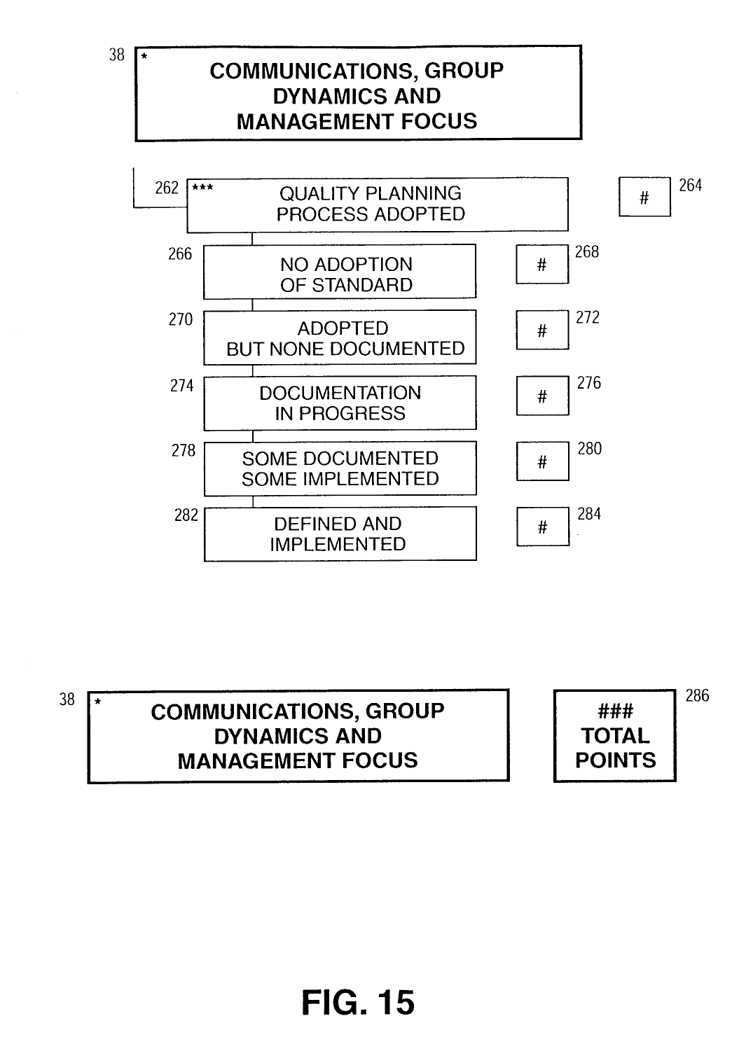

The final subcategory measures the level of adoption of documentation of the Quality Planning Process, FIG. 15, block 262. Block 266, 270, 274, 278 and 282 lists varying levels of an adoption of a process. These include No Adoption of Standard, block 266, Adopted but None Implemented, block 270, Documentation in Progress, block 274, Some Documented and Some Implemented, block 278 and Defined and Implemented, block 282. Block 264 is the total point values for this measurement criteria, which is the sum of 268, 272, 276, 280 and 284.

Block 286 shows the total point values for Block 38, Communications, Group Dynamics and Management Focus category.

### Incoming Inspection of Materials

In the Figures, measurement categories are preceded by a star, measurement subcategories are preceded by two stars, and measurement criteria are preceded by three stars.

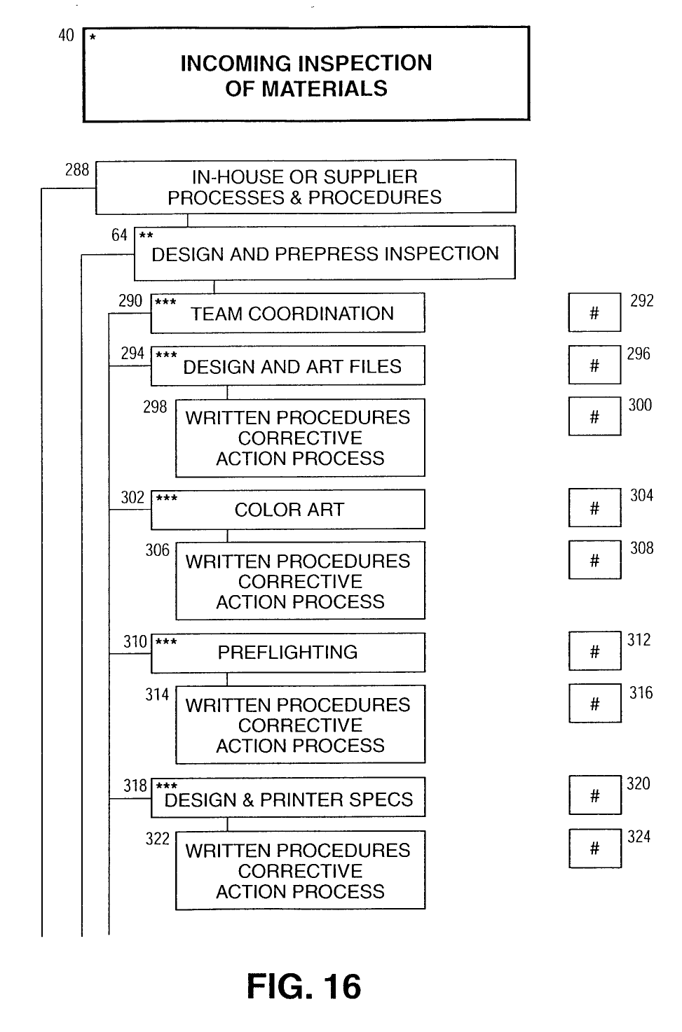

For all materials coming into the plant there must be procedures for inspection. Specifications must be developed and communicated to each supplier, specifically In-House Supplier Processes and Procedures, FIG. 16, block 288. The Incoming Inspection of Materials category is detailed in FIGS. 16, 17, 18, 19, 20, 21, 22 and 23.

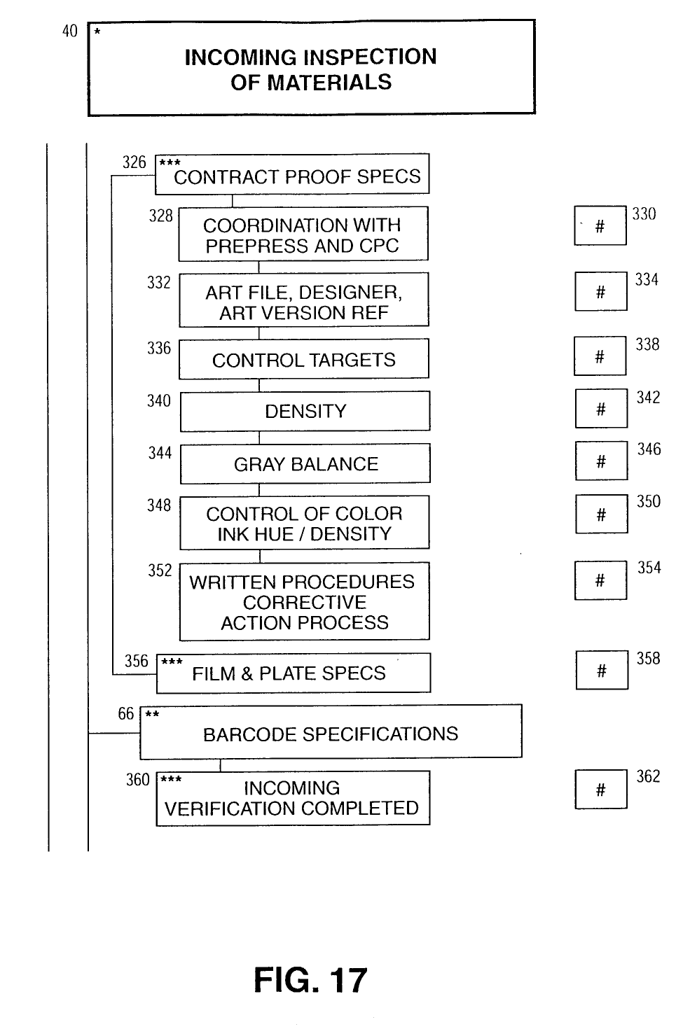

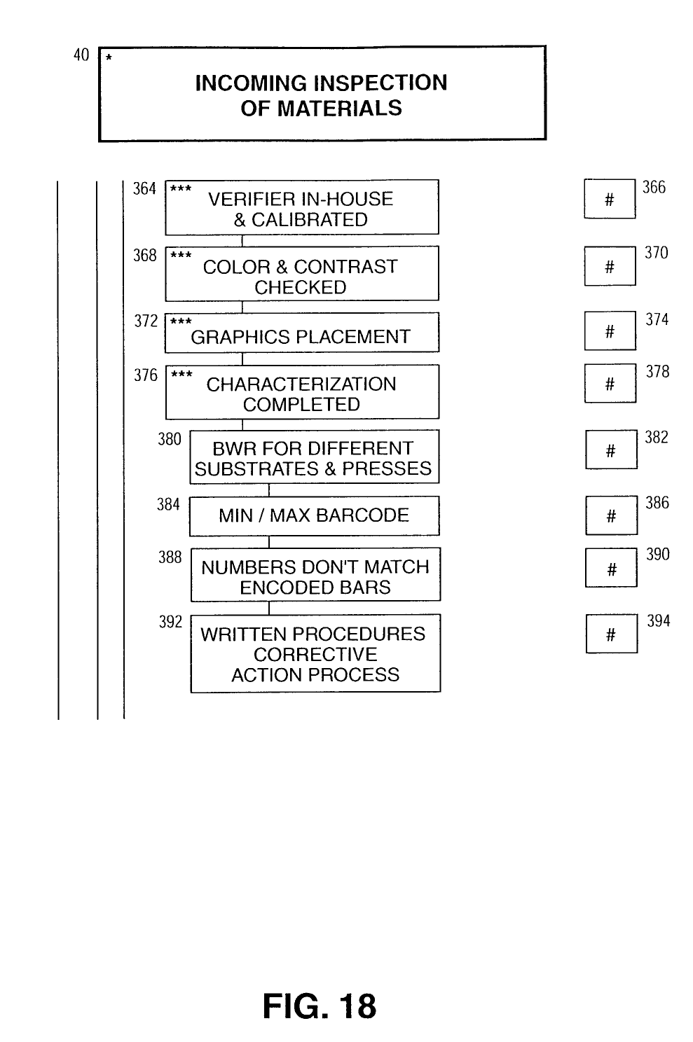

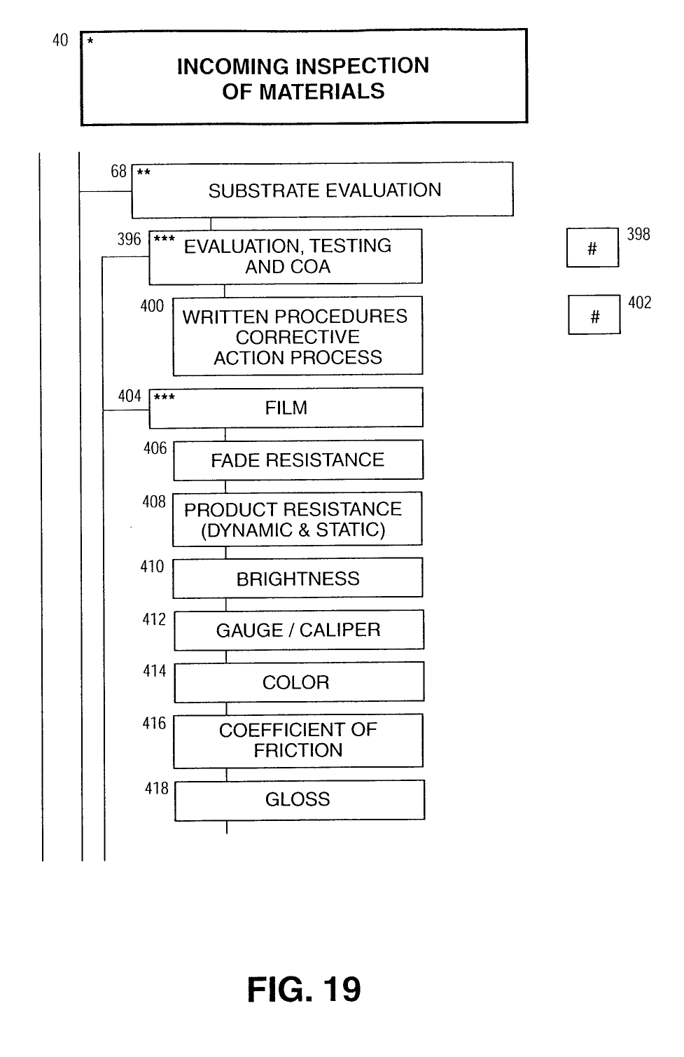

There must be Written Procedures and Corrective Action Processes for all stages of the process. These include Design and Prepress Inspection, FIG. 17, block 64; Barcode Specifications, block 66 and Substrate Evaluation, FIG. 19, block 68. Written Procedures and Corrective Action process for many of the stages are noted in FIG. 16, block 298, 306, 314, 322, FIG. 17, block 352, FIG. 18, block 392 and FIG. 19, block 400.

The elements of Design and Prepress Inspection include Team Coordination, FIG. 16, block 290. The team comprised of representatives from all departments, suppliers and the customer must work together to ensure quality of materials, processes used and expectations of the final printing.

Design and Art Files, block 294 are a critical step in the process. These files must be made to the specific package size, must meet the print method requirements and must be accurate for copy and color designations.

Color Art, block 302 must be and accurate representation of the customer's expectations. This art can be in the form of a color transparency, illustration art, digital photography, digital illustration or film separations, also referred to as CTs (continuous tone films).

Preflighting, block 310 is the process to test the design file before sending into final production. Some of the checkpoints may include color art placement, linked files, computer virus check, font review and assembly. The art must be made to meet the Design and Printer Specifications, block 318. This can include the number of colors to be printed, the printing process, the color sequence and the substrate.

Contact Proof Specifications, FIG. 17, block 326 is required to ensure the proof that will go to press as the target can be reproduced. Many consumer product companies sign off on a proof that is not made to press specifications. The print results will not match that of the proof that the customer has approved. To ensure the proofs are made correctly some of the steps and elements to be included in prepress proofs are Project Coordination with Prepress and Consumer Product Company, block 328; a listing of the Art File, the designer who prepared it and any Art Version Number for tracking purposes, block 332; Control Targets, which are squares of colors made of solid or screened patches that can be measured, block 336; Density readings that indicate the amount of color applied to the proof which must correlate to the printing conditions, block 340; Gray Balance, which is the measurement of the three process colors in combination make a gray which indicates a balance of color, block 344 and Color Control in ink matching for Ink Hue (actual ink color) and Density (amount of ink to be printed on the substrate), block 348.

Film and Plate Specifications, block 356 is a check of the materials (films) that will make the printing plates. There are also plates that do not require films called direct to plate. These plates are made from computer files and the plates are created electronically. By using film or digital data the reviews and corrective action processes must be in place. Point values for subcategory Design & Prepress Inspection, block 64 are listed in FIG. 16, block 292, 296, 300, 304, 308, 312, 316, 320, FIG. 17, block 324, 330, 334, 338, 342, 346, 350, 354 and 358.

Barcodes on retail packages, UPC codes, as we know them are used for store checkout purposes. Similar barcode symbols are also used at all stages of shipments and deliveries on the shipping cases. There are a number of barcode types. An international organization, UCC, Uniform Code Council provides manufacturer's numbers and guidelines for the use of symbols. It is up to each company, supplier and printer to ensure the printed package barcode will scan. Barcode Specifications, FIG. 17, block 66 details the elements for testing and checking for barcodes. Barcodes can be supplied as a film transparency, others as only a reference to the number. Incoming Verification must be completed to ensure the proper information is received, block 360. There is equipment that will read and verify barcodes for proofs and printed material. This equipment must be in-house (prepress provider and printer) and must calibrated to ensure consistent and reliable readings, FIG. 18, block 364. Barcode ink color must have enough contrast against the substrate for the barcode to scan, block 368. The placement of the barcode in the graphics, block 372 must be in alignment with the printing direction. This is the best method in printing the clearest bars. Printing the code cross direction can cause a blurred reproduction reducing scannability. For the development of barcode specifications a printer should complete a press characterization, block 376. This should be completed to determine the BWR (Bar Width Reduction) for Different Substrates and Presses, block 380. The symbol bars will expand slightly when printed due to the nature of the printing process and potential absorbency of the substrate. To allow for this growth the bars are reduced in the prepress stage. A characterization will allow the printer to test different sizes of barcodes with different BWR on different substrates. This will ensure the prepress is correct and that scannable barcodes are printed during production. MIN/MAX barcodes, block 384, refers to the actual size of the barcode. Typically symbol size is sized at 100% based on the UCC guidelines. Smaller packages require reduced sizes but may be difficult to produce accurately. Testing a number of symbol sizes will determine what sizes they can reproduce accurately for the different substrates tested. There must be a check of the encoded bars to the human readable numbers, block 388. The bar and clear space widths are encoded to create the numbers. The human readable numbers are sometimes changed in the artwork instructions with no reference to the bars. If the numbers do not match the bars the product will not scan and will be rejected by the customer. Point values for the Barcode Specifications subcategory, block 66, are listed in FIG. 17, block 362, FIG. 18, block 366, 370, 374, 378, 382, 386, 390 and 394.

The material printed is called the substrate. There are many forms that are used for package printing. The surface, material structure, thickness, color and appearance differ greatly. Material testing is necessary to ensure the material meets the specifications for machinability, printing and product application requirements, FIG. 19, block 396. COAs, Certificate of Analysis from the material supplier can also be used for proof of quality. Written Procedures and Corrective Action, block 400 are mandatory to provide consistent checking and evaluation and a means to correct any problems or issues.

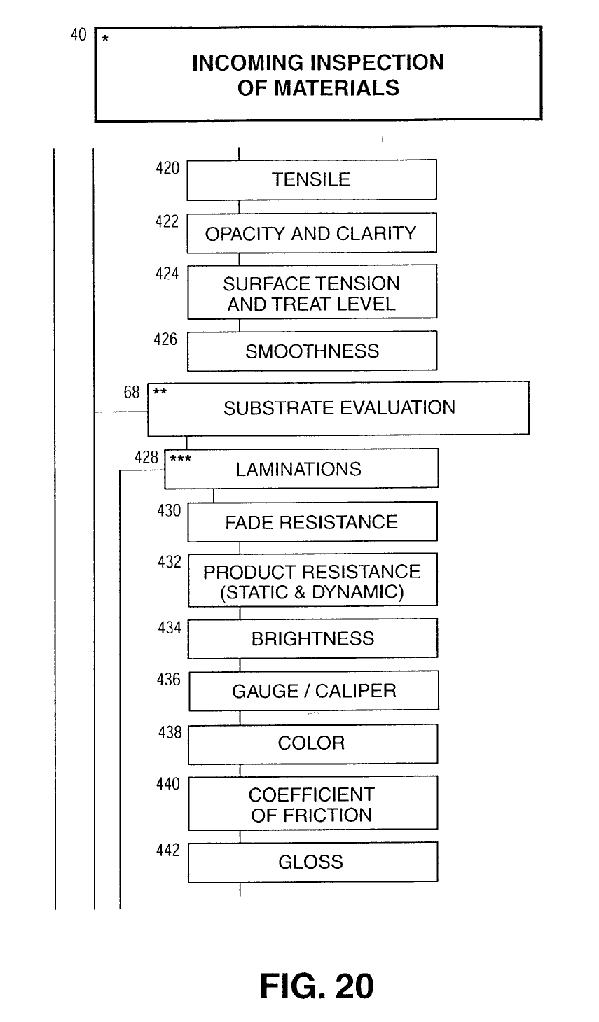

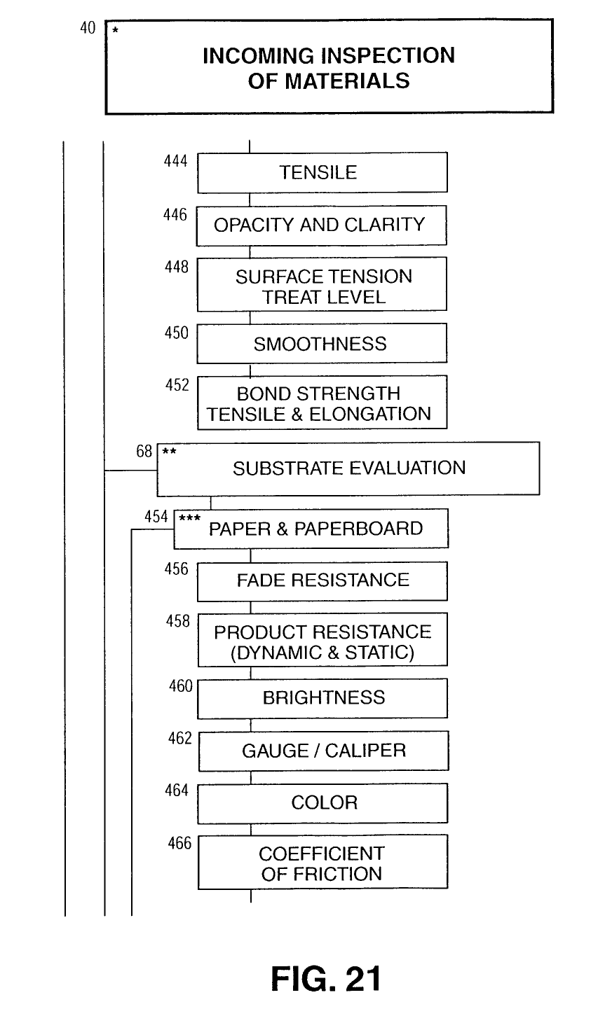

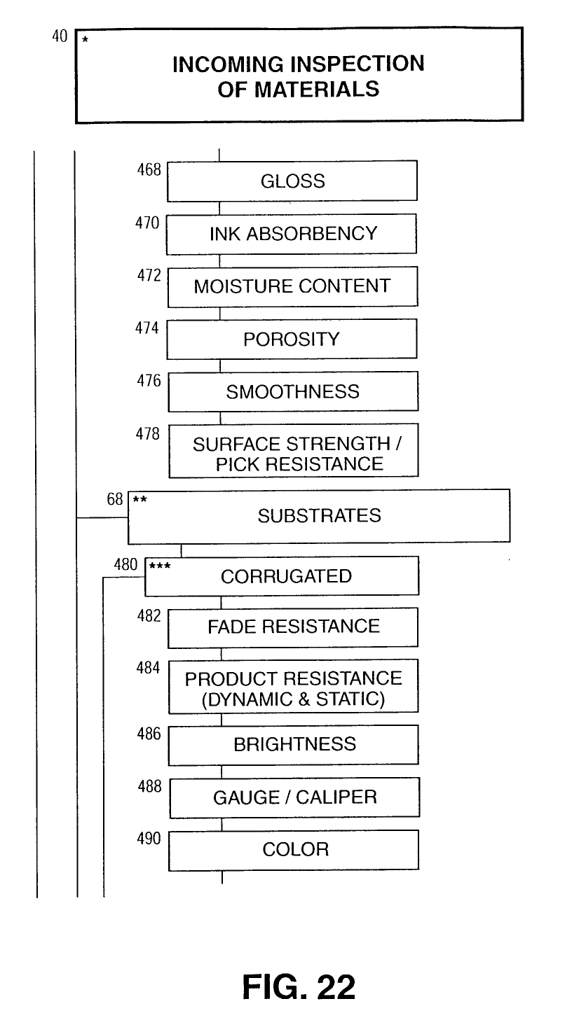

One method of defining package substrates is by material type. These may include Film, block 404, Laminations, FIG. 20, block 428, Paper and Paperboard, FIG. 21, block 454 and Corrugated, FIG. 22, block 480. Film is for plastic bags, paper pouches and wraps (candy wraps). Laminations are a combination of one or more materials laminated to provide a material for strength or product barrier. With laminations the printing is either surface printed or reverse printed before the lamination of the various structures are combined. Paper and paperboard are used for cartons and labels. These materials vary in quality. Some materials are made from virgin pulp and finely calendared or coated resulting in the smoothest printing surface. Some of these include clay coated news, CCN and solid bleach sulfate board, SBS. Other paperboards are made from recycled board. Clay coated News, CNN or more generically called coated recycled board, CRB. The surface on these materials is an off white or gray color and has a rougher surface texture for printing. There are uses for all types of paper and board configurations. Each company and product category will require specific paper and board traits. Corrugated is board that is made from three sheets of kraft or bleached kraft board. The center sheet is fluted and glued to the top and bottom sheets. Much of this type of board is used for shipping cases that requires one color line printing. More products now are being printed on combined corrugated (three layers constructed) requiring a better printing surface, better color (white and brightness) and better ink hold out on press.

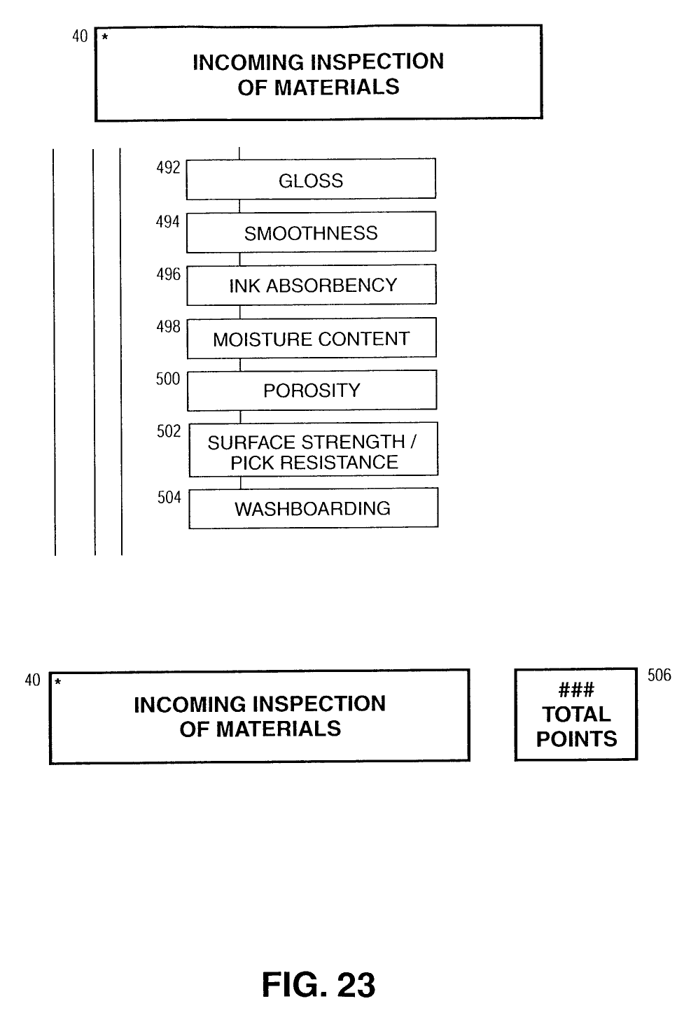

All substrates must be checked for certain property of functional tests. Many of these same tests are made on all types of substrates. These are shown in FIGS. 19, 20, 21, 22 and 23. For packaging to keep from fading on the store shelf or in outside environments they must pass fade resistance tests, FIG. 19, block 406, FIG. 20, block 430, FIG. 21, block 456 and FIG. 22, block 482. The package must also withstand the effects of the product itself. Some products will smear or erode the ink. Product resistance tests (both dynamic and static) are completed, FIG. 19, block 408, FIG. 20, block 432, FIG. 21, block 458 and FIG. 22, block 484. To provide a high quality printed color the substrate must have a strong brightness. This is measured by how much light is reflected from the substrate surface, FIG. 19 block 410, FIG. 20, block 434, FIG. 21, block 460 and FIG. 22, block 486. The thickness of the substrate is referred to as caliper or gauge, FIG. 19, block 412, FIG. 20, block 436, FIG. 21, block 462 and FIG. 22, block 488, must be within the specification tolerances to ensure consistency of print. The color of the substrate must meet the requirements. There are, for example different shades of white. Ink hues may require adjusting to match the target proof due to substrate color variation. Substrate color can be measured with a spectrophotometer. Color is listed in FIG. 19, block 414, FIG. 20, block 438, FIG. 21, block 464 and FIG. 22, block 490. Coefficient of Friction, FIG. 19, block 416, FIG. 20, block 440 and FIG. 21, block 466, is the slip resistance of the printed material. A certain slip factor is necessary for the package material to perform correctly on packaging machinery. Gloss, FIG. 19, block 418, FIG. 20, block 442, FIG. 22, block 468 and FIG. 23, block 492, measures the amount of light reflected from the substrate surface. The glossier the surface the brighter and more vivid the final printed piece will be. Tensile Strength, FIG. 20, block 420 and FIG. 21, block 444, is the amount of stretch or strength a film has before the breaking point. Certain substrates will require stronger tensile strengths to run through the press. Opacity and Clarity, FIG. 20, block 422 and FIG. 21, block 446, define the amount of light that comes through a substrate and how much is seen through the material. More show through will affect the appearance of the final printed product. The more opaque a film is the less likely the product will show though like frozen food pouches. Surface Tension Treat Level, FIG. 20, block 424 and FIG. 21, block 448, applies to films and laminations. It is the treatment to the film after production that allows the ink to adhere to the film. Smoothness, FIG. 20, block 426, FIG. 21, block 450, FIG. 22, block 476 and FIG. 23, block 494 is the surface texture of the printing surface. The smoother the substrate the more control a printer will have during the printing process. Bond Strength and Tensile Elongation, FIG. 21, block 452, refers to the strength of the bond of the lamination layers and the combined strength of the complete structure. Surface Strength and Pick Resistance, FIG. 22, block 478 and FIG. 23, block 502, is an attribute of paper and paperboard. The ink must adhere to the board and not pick off the paper or board surface as it goes thought the press. The following substrate properties that may be required to test are for corrugated substrates. Ink Absorbency, FIG. 23, block 496, is the rate at which the ink absorbs into the substrate. The more absorption the less ink will remain on the top of the substrate resulting in poor color. Moisture Content, FIG. 23, block 498 and porosity will also affect the printability of the substrate since these properties affect ink hold out on the substrate. Washboarding, FIG. 23, block 504, is a property of corrugated. This is the indentation of the combined corrugated board that is created with the gluing of the fluted kraft paper with the inner and outer layers. The more washboarding the more difficult it will be to print since the surface is not smooth and uniform.

The total point values for the Substrate Evaluation subcategory is noted in FIG. 19, block 398, for the Evaluation, Testing and COA and in block 402 for Written Procedures and Corrective Action. The total score for the Incoming Inspection of Materials is noted in FIG. 23, block 506.

### Print and Press Variables

In the Figures, measurement categories are preceded by a star, measurement subcategories are preceded by two stars, and measurement criteria are preceded by three stars.

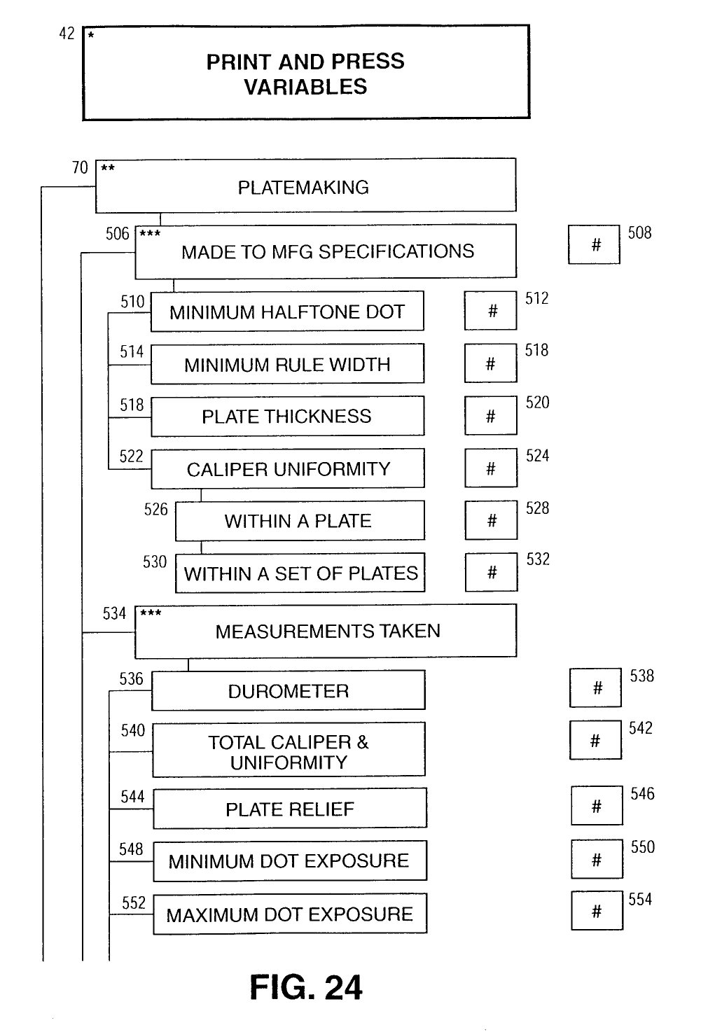

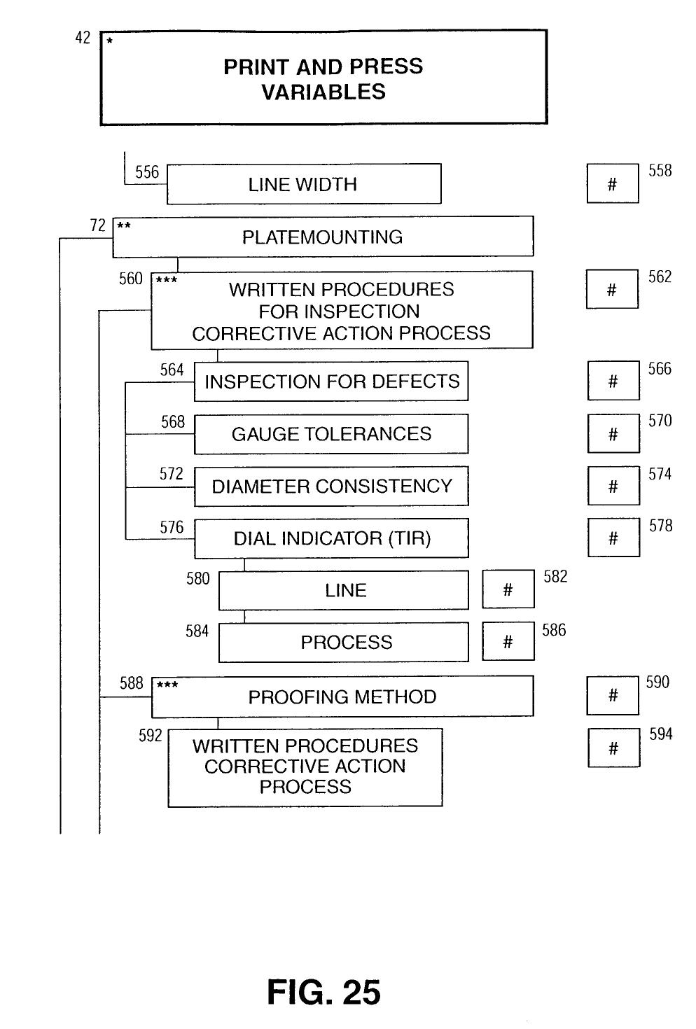

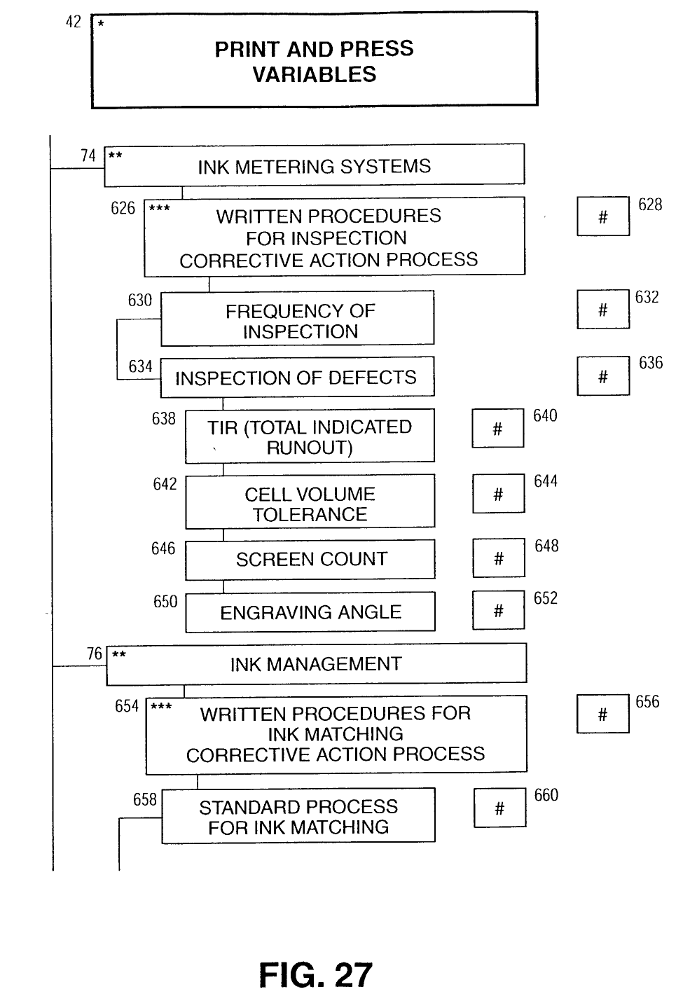

Specifications for the press and print variables must be set and all materials must be manufactured to them. Procedures for manufacturing and inspection must be followed to ensure all the variables are in specification. The Print and Press Variables section is detailed in FIGS. 24, 25, 26, 27, 28, 29, 30 and 31. The key areas in this section are Platemaking, FIG. 24, block 70, Platemounting, FIG. 25, block 72, Ink Metering Systems, FIG. 27, block 74 and Ink Management, block 76. Plates must be made to the manufacturers specifications, FIG. 24, block 506. One of the variables to monitor is minimum halftone dot, block 510. The smallest dot that can be held in a plate will produce the smallest dot resulting in good definition and detail in the final printed piece. Minimum rule thickness, block 514, is the smallest rule that can be held in a plate. Plate thickness, block 518 must match the cylinders for the press. Caliper Uniformity, block 522, of the plates must be even to ensure the plates print evenly on press and the plates must have the same caliper within a plate, block 526 and within a set of plates, block 530. The point ranges for these variables are shown in block 512, 518, 520, 524, 528 and 532 with the total point values shown ion block 508.

Some of the measurements taken, block 534 include Durometer, block 536, the compressibility of the plate material (flexographic plate material only), Total Caliper & Uniformity (flexographic plates only), block 540, Plate Relief (flexographic plates only), block 544, the Depth of the Plate from the top of the raised image area to the bottom of the plate or floor, Minimum Dot Exposure, block 548 and Maximum Dot Exposure, block 552, both regulate the amount of light that exposes the plate for quality plate production. Line Width, FIG. 25, block 556, must be measured as another measure of proper plate exposure and plate processing. Point values assigned to these platemaking measurement criteria are shown in FIG. 24, block 538, 542, 546, 550, 554 and FIG. 25, block 558.

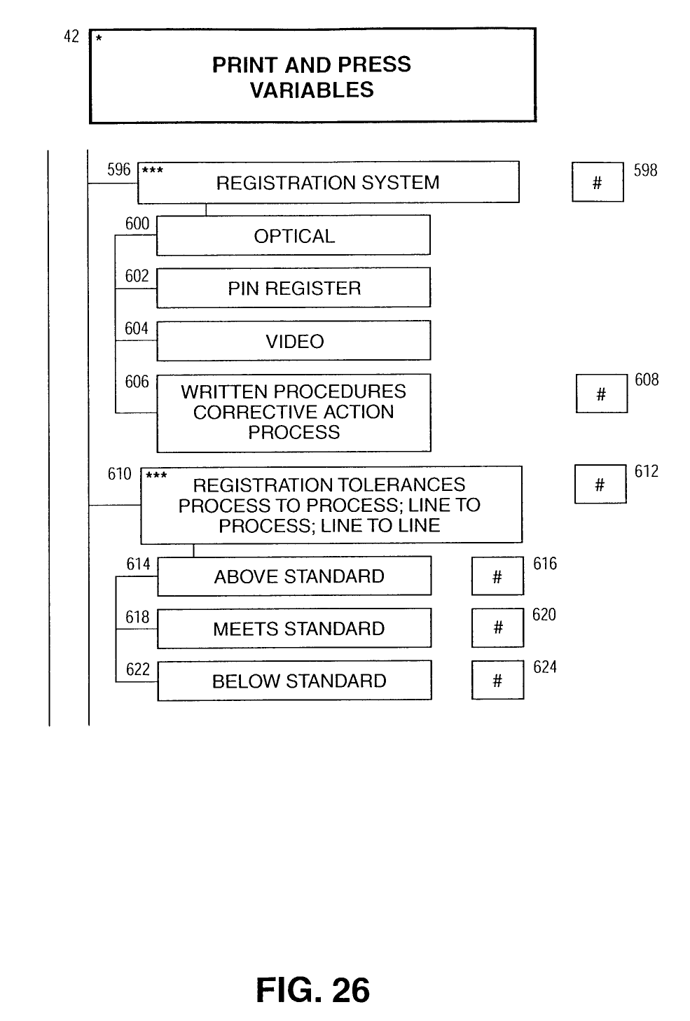

Platemounting, block 72 is the process of placing the plate to the press or printing cylinder. This is completed for lithography and flexography. There must be Written Procedures for Inspection and a Corrective Action Process, block 560 to ensure the process is completed accurately. Total point values for written procedures shown in block 562. Some of the items that should be part of the inspection include block 564, Inspection for Defects in the Plates; block 568 Gauge Tolerances, of the mounting cylinder; block 572 Diameter Consistency of the plate cylinder and block 576 Dial Indicator Runout (TIR), the accuracy of the diameter of the cylinder from side to side. TIR must be checked for cylinders used to print block 580, Line Copy (type or solid areas of color) and for block 584, Process Color (photography, illustration art). Point values for these sections are shown 566, 570, 574 and 578 which is a total of block 582 and 586. Mounted plates must be proofed. There is a number of Proofing Methods, block 588. Written Procedures and Correction Action Process, block 592, are essential to ensure the proofing steps are used and any deviation is corrected. The point value for Proofing Methods is shown in block 590 and 594. For the plates to print in register a Registration System, FIG. 26, block 596 must be used. Some of these systems are Optical, block 600, Pin Register, block 602 and Video, block 604. For this procedure there must also be Written Procedures and Corrective Action Process, block 606. The total point values for the Registration System is noted in block 598 and 608.

Registration is where the colors line up to create a clear, not fuzzy image. There are registration tolerances for process color to process; line copy to process color and line copy to line copy, block 610. This invention designates the registration into three levels. Registration is defined as Above Average, block 614, Meet Standard, block 618 and Below Standard, block 622. The point system ranges with the most point values awarded to the Above Standard descending to Below Standard, block 616, 620 and 624. The total point values are shown in block 612.

Ink Metering Systems, FIG. 27, block 74 are devices that provide ink to the press. These units must be in good working order and Written Procedures for Inspection with a Corrective Action Process, block 626 must be in place. Total point values for these procedures are in block 628. Areas to be reviewed include Frequency of Inspection, block 630 with the total point values shown in 632. Some of the Inspection of Defects, block 634 may include TIR (Total Indicated Runout), block 638, the Diameter Consistency of the ink or anilox rolls; Cell Volume Tolerance, block 642, the measurement of the depth of the indentations in the ink transfer rollers (flexography and gravure); Screen Count, block 646, the number of cells of the indentations in the ink metering roll (flexography) and image rolls (gravure) and Engraving Angle, block 650, the slant or angle of the screen etched in to the cylinder. Total point values for each of these Inspection Defects are shown in block 640, 644, 648 and 652 with the final total in block 636.

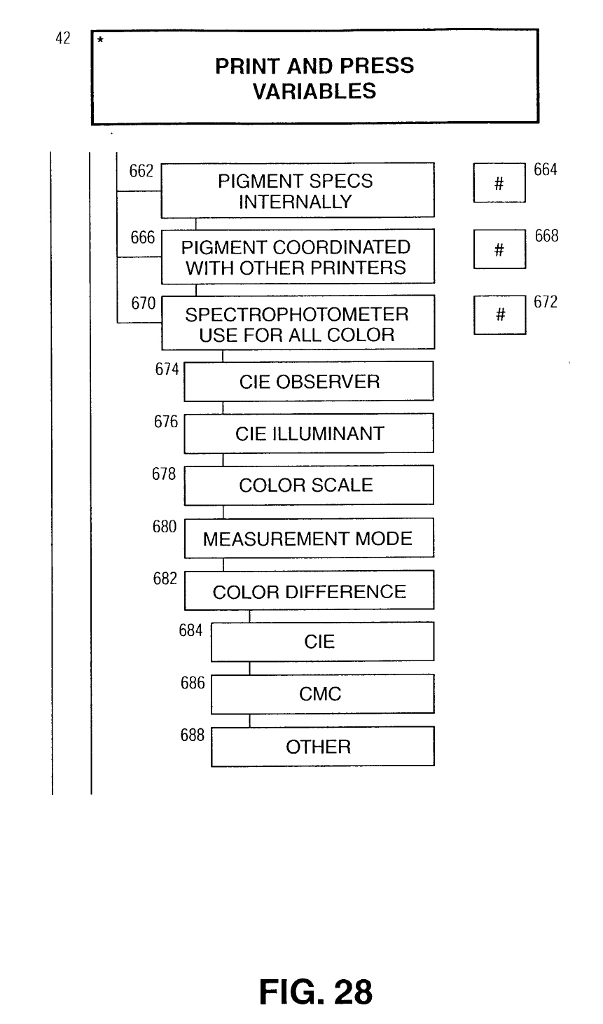

Ink Management, block 76 is the process of developing inks (color) and managing the color throughout the printing process. For this process Written Procedures for Ink Matching and a Corrective Action Process, block 654 have a total point value in block 656 which is comprised of total point values from FIG. 27, block 660, FIG. 28, 664, 668 and 672. Some of these procedures include a Standard Process for Ink Matching, block 658, Ink Pigment Specifications for the printing plant, FIG. 28, block 662, Pigment Specifications coordinated with other printers of the same package brands of their customer, block 666 and the use of a Spectrophotometer to measure all color matches, block 670. The spectrophotometer measures color in a three-dimensional color space, usually using L*a*b* values. The Lightness value (L*) indicates how light or dark a color is. The a* value indicates the position on the red-green axis and the b* is the position on the yellow-blue axis. A color target is read using the spectrophotometer and L*a*b* values are determined assigning the color in a specific point in color space.

The Spectrophotometer should comply with industry specifications such as, CGATS 0.5-1993 Graphic Technology—Spectral Measurement and Colorimetric Computation for the Graphic Arts. The equipment must follow specifications for Observer block 674, the angle or range the sample is viewed CIE Illuminant block 676, the light source, the Color Scale block 678, the color readings Measurement Mode block 680, the measurement system that will be used (L*a*b*, LCH, etc.) and Color Difference block 682, a tolerancing method that will determine if the color match compared to the target match is acceptable. Color Difference is defined by using CIE block 684, CMC block 686 or another method block 688 of color tolerancing.

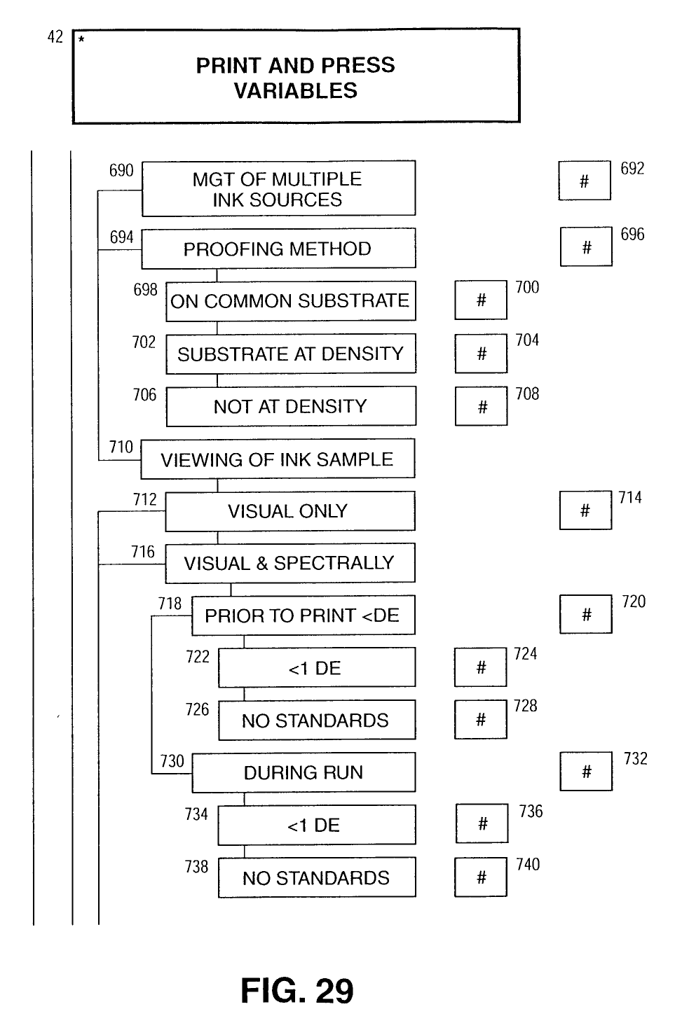

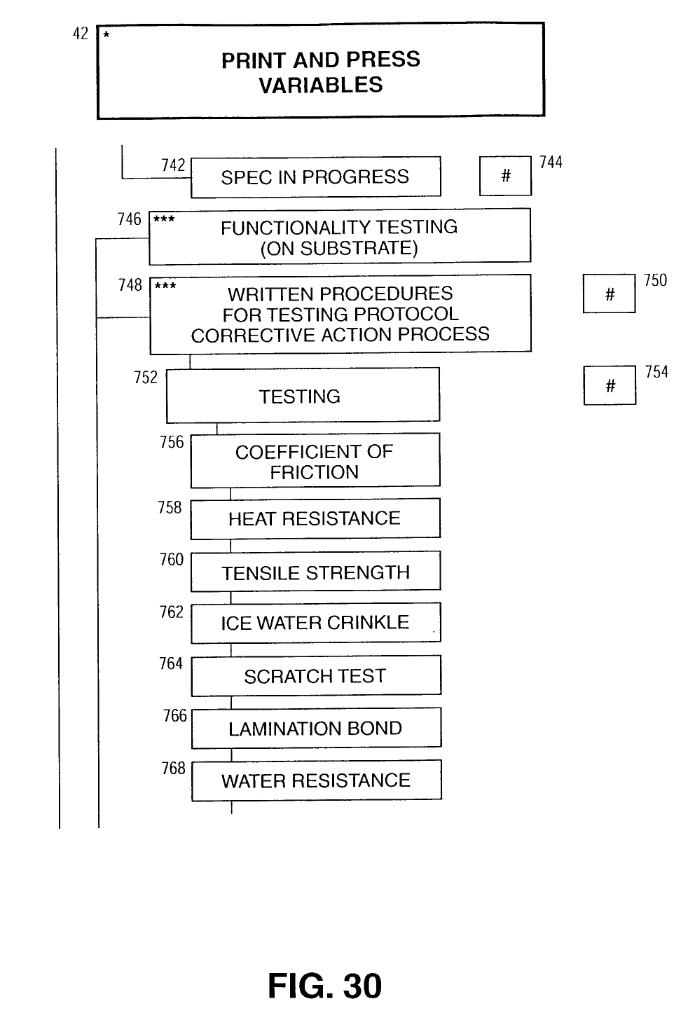

It is important Manage Multiple Ink Sources, FIG. 29, block 690. This occurs when a number of ink suppliers prepare inks for different printers for the same package design. The choice of ink pigments and ink formulas will result in a different color match even when the same sample color target is used for ink matching. The total point values for the management of multiple ink sources is shown in block 692. The Proofing Method, block 694 is a variable that must be managed. Different proofing methods will not produce accurate ink swatches. The proofing of the ink must be done on a Common Substrate, block 698, at the Correct Density, block 702. If the ink is not proofed at the proper Density, block 706 than the point values awarded will be less, block 708. The total point values for Proofing Method is block 696, which is a total of block 700, 704 and 708. Ink samples must be viewed by a number of ways to determine the best ink match, block 710. The best way is to view the sample Visually and Spectrally, block 716. If viewed Visually Only, block 712 the point values awarded will be less, as noted in block 714. Color viewing and measurement must be done Prior to Printing, block 718 and During the Run, block 730. If there are No Standards used, block 726 and 738, point values awarded will be less, block 728 and 740. If the tolerance range is tight, which may be below some range of Delta E the point values awarded will be higher, block 724 and 736. The point values for these two requirements are shown in block 720 and 732. If no Specifications are in Progress, FIG. 30, block 742 for the Prior to Print and During the Run measurement criteria the total point values are shown in block 744.

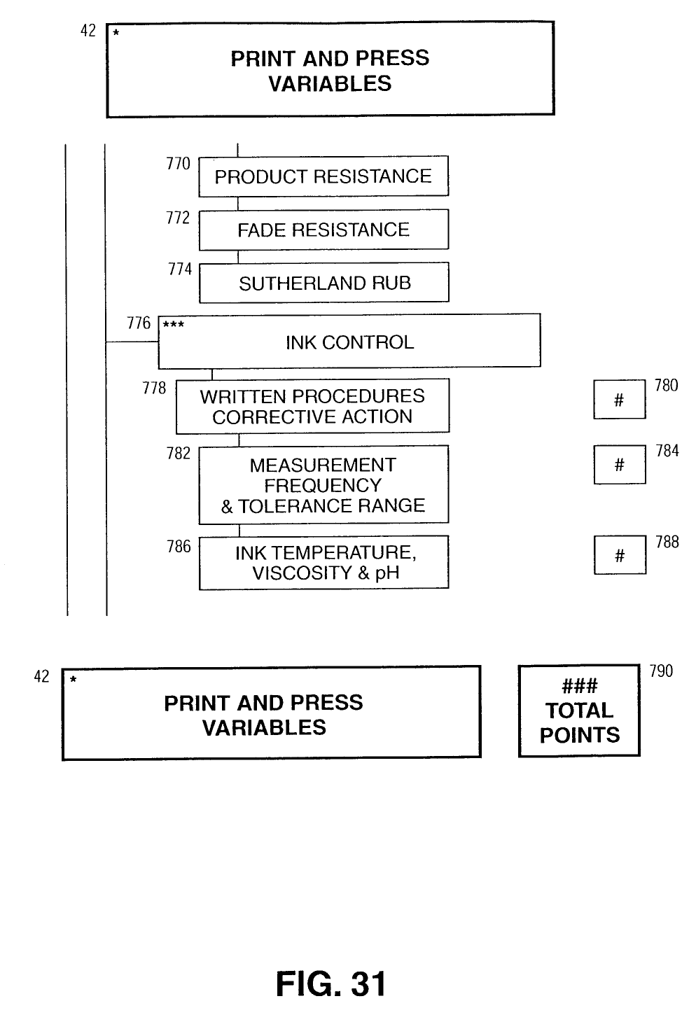

Ink Functional Testing on the substrate of the ink on the substrate, block 746 is defined as how the ink withstands the environment of a package in the distribution channel, on-shelf and after the consumer takes the product home. It is critical to have Written Specifications for a Testing Protocol and Corrective Action Process, block 748, with point values awarded noted in block 750. Some of the testing procedures, block 752 that may be used include: Coefficient of Friction, block 756, which is the amount of slip a substrate has after printing, Heat Resistance, block 758, the amount of heat the printed ink can withstand, Tensile Strength, block 760, the strength a flexible material has when pulled in one direction, Ice Water Crinkle Test, block 762, used primarily for frozen food packaging, this tests for ink breakdown after sitting in ice water, Scratch Test, block 764, to test ink adhesion to the substrate, Lamination Bond Strength, block 766, the strength of the lamination of one of more substrates, Water Resistance, block 768, the ability for the ink to adhere in a moist environment, Product Resistance, FIG. 31, block 770, the ability of an ink remain unchanged when in contact with the product, Fade Resistance, block 772, the ability for the ink to not fade under typical or severe lighting conditions and Sutherland Ink Rub Test, block 774, to test the effect of the rubbing of a shipping case against the package or a package against a package. Total point values for tests completed is shown in FIG. 30, block 754.

To ensure consistency and control of the ink during the printing process ink controls, block 776 must be established. Written Specifications and a Corrective Action Process, block 778 are important to manage the variables. There must be a Measurement Frequency and Tolerance Range established, block 782. Ink Viscosity, the measurement of ink fluidity and the pH, block 786 are important to control as these variables influence how the ink will print. The scores for these processes are shown in block 780, 784 and 788. The total point values for the Print and Press Variables is noted in FIG. 31, block 790.

### Production Print Preparation and Standardization

In the Figures, measurement categories are preceded by a star, measurement subcategories are preceded by two stars, and measurement criteria are preceded by three stars.

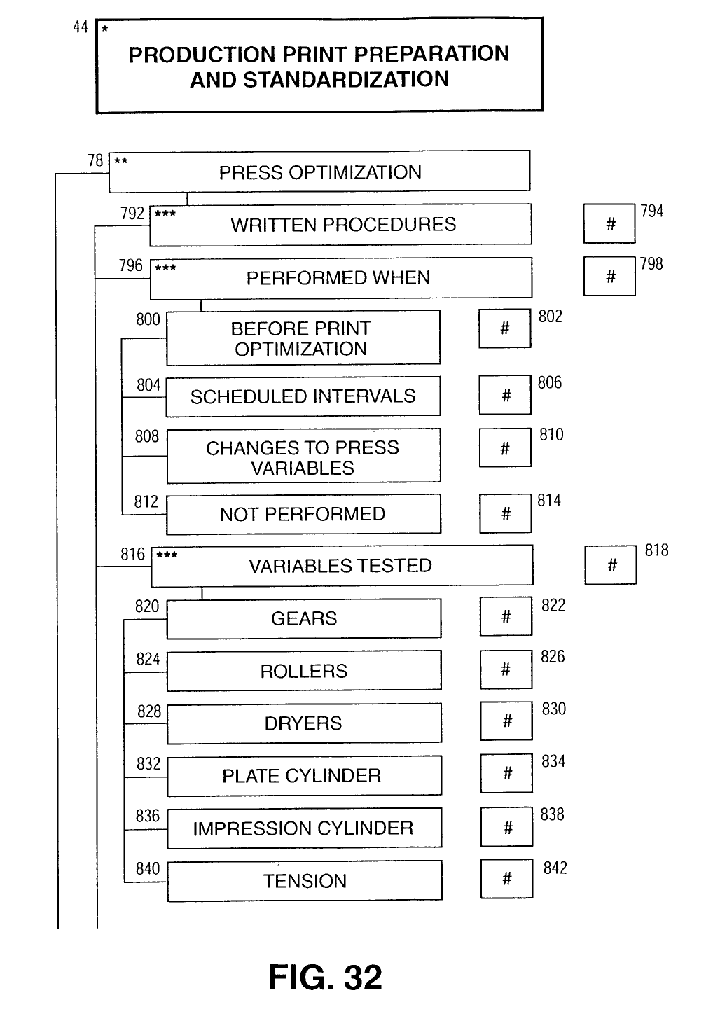

To predict and deliver consistent printing that matches that of the customer's target a printer's presses must be in good working order, the materials made must be to specifications derived from press optimization, print optimization and characterization data. Print Production Preparation and Standardization category, block 44 is detailed in FIGS. 32. 33, 34, 35, 36 and 37.

To start with a press that is in good working order a Press Optimization, FIG. 32, block 78 must be completed. This process allows the development and correction of press variables that will affect how the press prints. Some of these include color to color registration, ink delivery and press settings. A Press Optimization should be repeated when press variables are changed thus detecting any mechanical problems. Written Procedures, block 792, must be established to ensure the Optimizations are conducted the same. Total point values for Written Procedures is noted in block 794. Optimizations should be conducted, block 796 on an Established Schedule and When Variables Change. Total point values for the Press Optimization is noted in block 802 and 806, 810 and 814 and are based on completing the Optimization Before Print Optimizations, block 800, Performed at Scheduled Intervals, block 804, when Changes to Variables are made, block 808. Less or no point values are awarded if Press Optimizations are Not Performed, block 812.

Variables Tested, block 816 for the Press Optimizations can include the following: The Condition and Wear of Gears, block 820, the Condition and Wear of Rollers, block 824, the Condition, Wear and Temperature of Dryers, block 828, the Condition and Wear of Plate Cylinder, block 832, the Condition and Wear of Impression Cylinder, block 836 and the Condition of Tension Controls, block 840. Point values for each of these variables are shown in block 822, 826, 830, 834, 838 and 842, with the total point values shown in block 818.

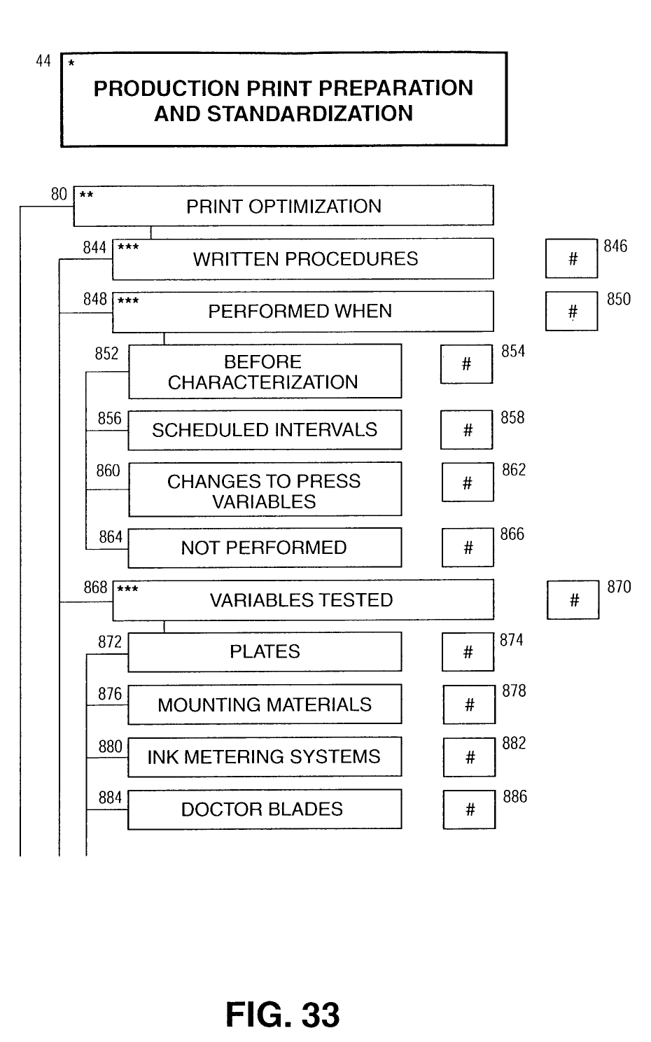

Print Optimization, FIG. 33, block 80 is the testing of the print variables or materials that are used in the printing process. This step follows the Press Optimization. There must be Written Procedures, block 844 with total point values shown in block 846. Print optimizations must be performed, block 848 Before the Characterization, block 852, on Scheduled Intervals, block 856 and when there are changes to the Press Variables, block 860. The point values given for these stages are shown in block 854, 858 and 862. If Print Optimizations are Not Performed, block 864 less or no point values are awarded if, block 866. Total point values for this measurement criteria is noted in block 850.

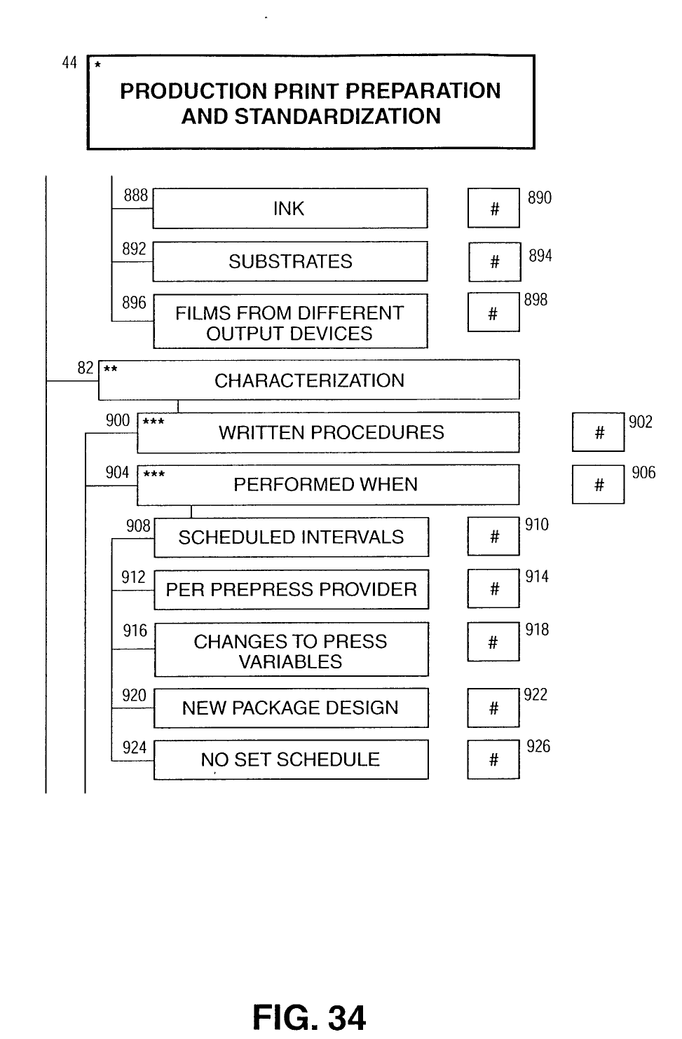

Some of the Variables Tested, block 868 includes: Plates, block 872, the actual printing plate that delivers the ink and image to the substrate, Mounting Materials, block 876, the material that adheres the plate to the plate cylinder, Ink Metering System, block 880, the Type of Ink Delivery System for the substrate and design requirements, Doctor Blades, block 884, the device that scraps off the excess ink from the anilox roll (flexography) or print cylinder (gravure), Ink, FIG. 34, block 888, the type of ink to be used, Substrate, block 892, the actual material to be printed and Films from different output devices or image setters and block 896, films provided by a prepress provider that may have differences in actual dot structure or vary but within specification. The point values for each of these variables is shown in FIG. 33, block 874, 878, 882, 886, FIG. 34, block 890, 894 and 898 with total point values in FIG. 33, block 870.

The Characterization, FIG. 34, block 82 is sometimes referred to as a press “fingerprint” measures and records how the press prints using specific ink systems, plates, mounting material as well as other variables. Data from this press test is used by the prepress provider to prepare film separations that will match that of the press requirements. It is important to complete the characterization according to exact press conditions since this data will determine the print curve. There must be Written Procedures, block 900 so each characterizations is performed consistently with total point values shown in block 902. Characterizations must be performed, block 904 under Scheduled Intervals, 908, for Different Prepress Providers, 912, when there are Changes to the Press Variables, block 916 and for New Package Designs, block 920. If there is No Set Schedule or characterizations are Not Performed, block 924, the prepress provider is not able to produce the correct films to match the target artwork. Less or no point values are awarded if press optimizations are not performed, block 926. The point values assigned to these events are shown in block 910, 914, 918, 922 and 926 with the total point values shown in block 906.

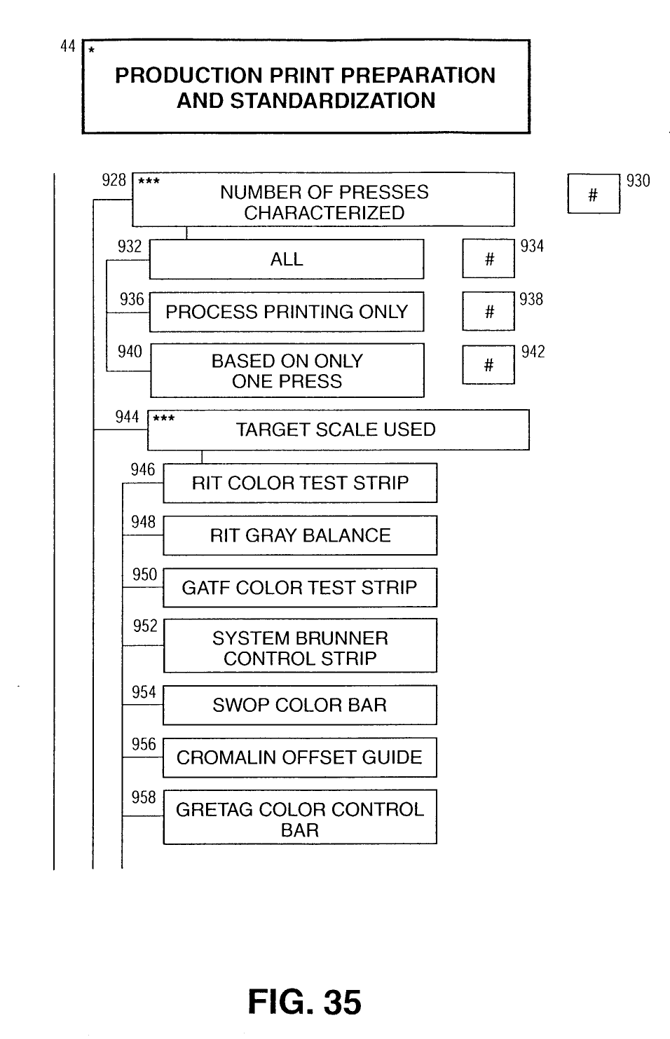

The Number of Presses Characterized, FIG. 35, block 928 is important to maintain press consistency and print accuracy to match the target proof. All Presses must be characterized, block 932. Some printers characterize only the presses they will use to print Process Color, block 936. Others will base the characterization on Only One Press, block 940. One of the biggest mistakes a printer can make is assume that data from one press will be duplicated on another. Point values awarded to these are listed in block 934, 938 and 942 with the total point values in block 930.

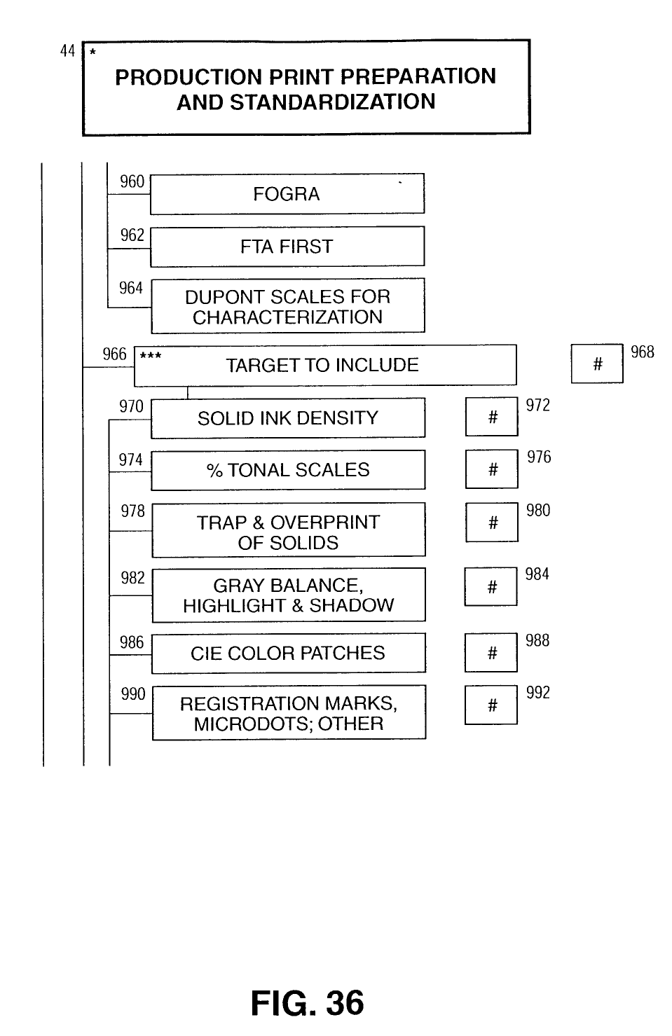

There is a number of created Target Scales used, block 944 for printing a characterization. Some of these include RIT (Rochester Institute of Technology) Color Test Strip, block 946, RIT Gray Balance, block 948, GATF (Graphic Arts Technical Foundation), block 950, System Brunner Control Strip, block 952, SWOP (Specifications for Web Offset Publications) Color Bar, block 954, Cromalin Offset Guide, block 956, Gretag Color Control Bar, block 958, FOGRA, FIG. 36, block 960, the FTA (Flexographic Technical Association) FIRST, block 962 and DuPont Scales for Characterization, block 964.

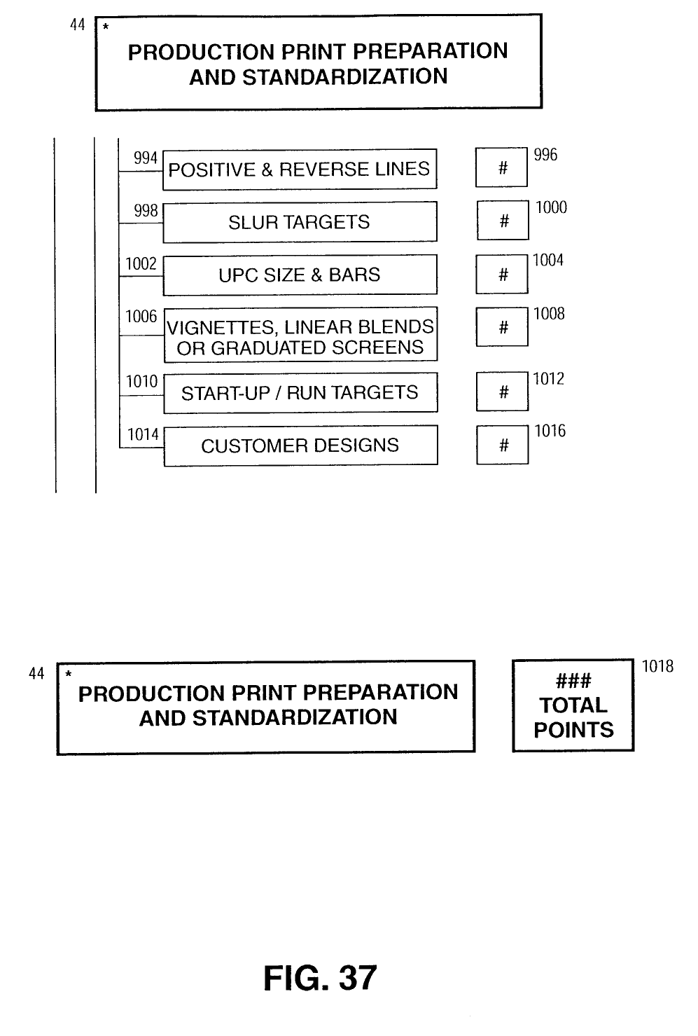

Each of these targets includes different test patterns. Each printer and prepress provider must determine the best on to use or develop one for their use. The necessary elements of the target, block 966, should include Solid Ink Density patches, block 970, which exhibit the best density a press can print for all colors, Percent Tonal Scales, block 974, a range of tints and tones that will be used to determine the print curve, Trap and Overprint of Solids, block 978, how effective the ink printed over each other prints, Gray Balance and Highlight and Shadow patches, block 982, to identify the curve the film will need to be made to for a match to the target, CIE Color Patches, block 986, are patches that are varying screen tints of process colors that are used to build ICC profiles for a press, Registration Marks, Microdots or other registration target, block 990, to measure color to color registration, Positive and Reverse (negative) Lines or Rules, FIG. 37, block 994, Slur Targets, block 998, used to show if the substrate is moving or being pulled faster that the press is driven which results in a smeared image, UPC Size and Bars, block 1002, to test for the best size and BWR for optimal scanning, Vignettes, Linear Blends or Graduated Screens, block 1006, to determine the smoothness of a blend and the break off point in a blend, Start-Up and Run Targets, block 1010, the actual targets that will be placed in the films for the set up of a press run and the actual production run and customer designs and block 1014, any particularly difficult Design Element. These elements are awarded point values as noted in FIG. 36, block 972, 976, 980, 984, 988, 992, 996, FIG. 37, block 1000, 1004, 1008, 1012 and 1016 with the total point values shown in block 968.

Total point values for the Production Print Preparation and Standardization category is noted in block 1018.

### Print Production Controls and Measurement

In the Figures, measurement categories are preceded by a star, measurement subcategories are preceded by two stars, and measurement criteria are preceded by three stars.

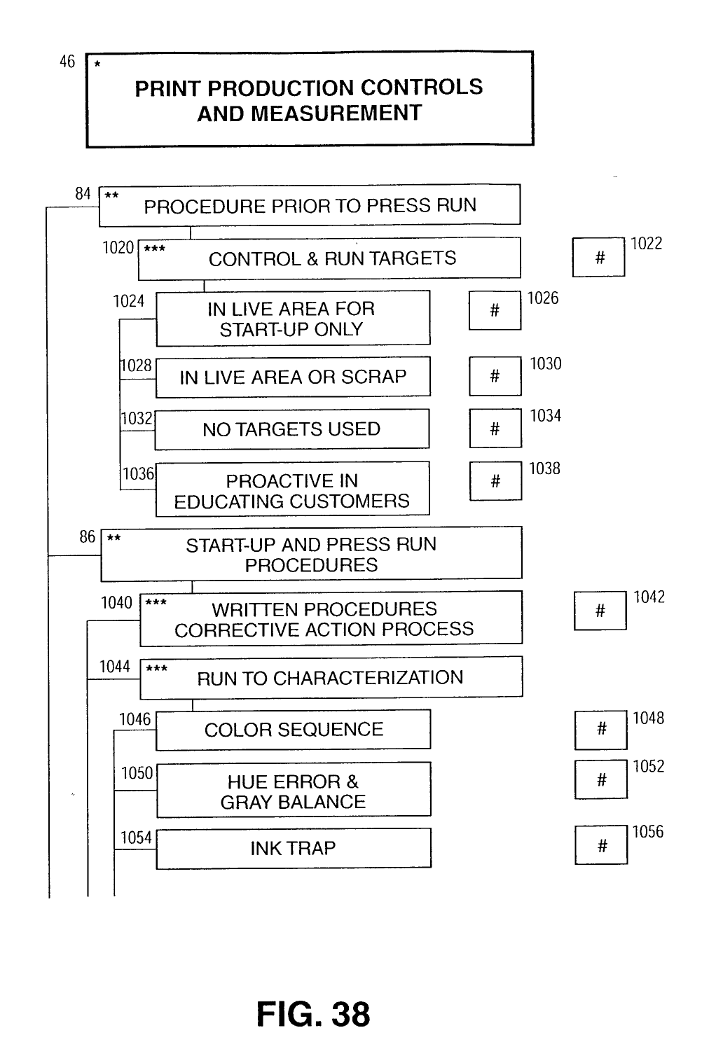

The entire process must be measured against standards that have been developed. A careful and detailed history of each job is mandatory to print consistently from roll-to-roll, shift-to-shift and run-to-run. Without the proper information at the beginning of the process you will not match the target. The category Print Production Controls and Measurement, block 46 is detailed in FIGS. 38, 39, 40, 41, 42, 43 and 44.

The quality of the print and the ability to match to a target is based on meeting and maintaining the press and print variables. Control Targets and Run Targets, block 1020 must be part of each job and measurement must be made during the entire process. The use of these targets must be planned prior to the run, block 84. These targets must be placed in live areas that will remain in the printed package for the entire run. There are varying ways targets are used. Some include block 1024 in Live Area for Start-Up Only, which is not the most advantageous method since on going measurement cannot be done. It is best to include the targets in the live area or scrap area on the package that will part of the start-up and the entire pressrun, block 1028. If no targets are used, block 1032 measurements cannot be made therefore variables cannot be measured against the characterization. It is in the best interests of the printer and their customer to include targets in the package. This can be accomplished by being proactive in educating customers, block 1036 as to the value of these targets. Point values awarded to each of these are noted in block 1026, 1030, 1034 and 1038 with the total shown in block 1022.

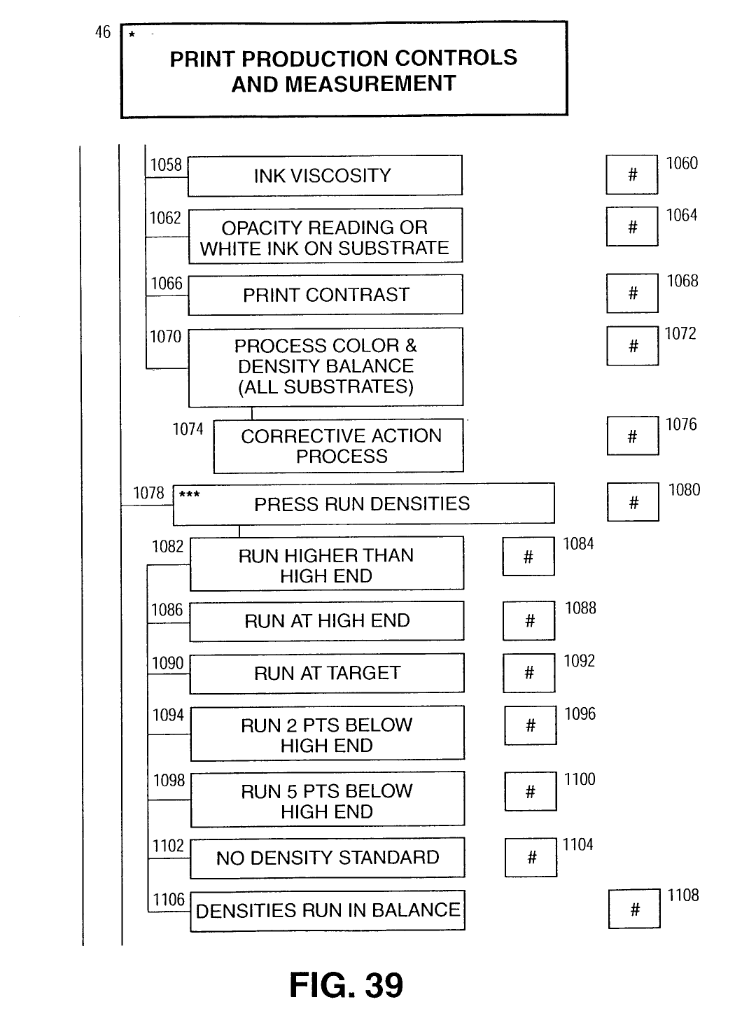

There are specific checks and measurements that should be made during the Start-Up and Press Run, block 86. There must be written procedures and a corrective action process, block 1040, so the process is completed the same each time. Total point values are shown in block 1042. The start-up and run must be made using the same conditions and using the same specifications as the characterization, block 1044. Some of these measurements may include block 1046, Color Sequence, the order in which the different colors are printed, block 1050, Hue Error & Gray Balance, the proper amounts of the process colors to produce a neutral gray and the hue error or shift in purity of a process color, block 1054 Ink Trap, the measurement of how well one ink prints over another, FIG. 39, block 1058, Ink Viscosity, the fluidity of the ink which will affect ink coverage and ink density resulting in variation to or an unacceptable match to the target artwork, block 1062 Opacity reading or white of the substrate, the amount of show through a stock has, primarily in flexible films that are opaque or clear, block 1066, Print Contrast, which is achieved with the highest ink density with the lowest dot gain for the highlight tones and the highest ink density in the shadow and solid areas and block 1070, Process Color and Density Balance, the amount of ink transferred to the substrate (density) in balance for all process colors. For the Process Color and Density Balance a separate Corrective Action Process, block 1074 is desirable. The point values for these variables are shown in FIG. 38, block 1048, 1052, 1056, 1060, FIG. 39, block 1064, 1068, 1072 and 1076.

Press Run Densities, block 1078, are the actual amount of ink that is printed on the substrate. The higher the density the stronger the image will be. For this section higher point values are awarded to a printer that can print above average densities. These density specifications will differ with substrate, printing process and printing press. The measurement criteria established for this invention for Ink Densities are in descending order, block 1082, Run Higher than High End, block 1086, Run at High End, block 1090, Run at Target, block 1094, Run 2 Points Below High End, block 1098, Run 5 Points Below High End and block 1102, No Density Standard Established. Points for these readings are noted in block 1084, 1088, 1092, 1096, 1100 and 1104 with total point values shown in block 1080. Additional point values are awarded, block 1108 for running the Densities in Balance, block 1106.

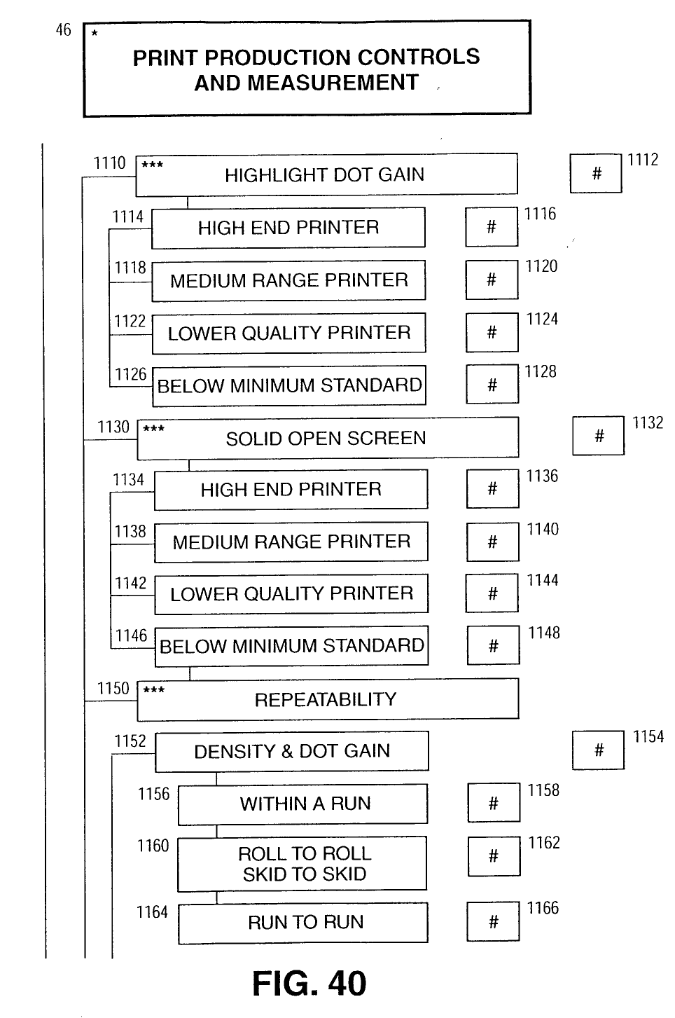

The next two measurement criteria Highlight Dot Gain, FIG. 40, block 1110 and Solid Open Screen, block 1130 are related. Highlight Dot Gain is the smallest dot that can be printed in the lightest tones in process art. Dot Gain occurs when the dot of ink expands or spreads when printed on the substrate. This can be due to the ink viscosity, the exposure of the printing plate or the amount of impression of the printing plate to the substrate or transfer roller. The lowest highlight dot gain will result in soft light tones in the lowest dot tonal range. By printing a Solid Open Screen, block 1130 the higher tonal range, darker tones will print strong but screens will print open to provide detail and definition in the darker areas of the process color image. To measure the degree of skill and technique these two measurement criteria are identified by the following classifications: High End Printer, block 1114 and 1134, Medium Range Printer, block 1118 and 1138, Low Quality Printer, block 1122 and 1142 and Below Minimum Standard, block 1126 and 1146. The ranges for these categories are determined by evaluating a large characterization database and a review of visual color and printed press samples. The point values assigned to these measurement criteria are shown in block 1116 and 1136, 1120 and 1140, 1124 and 1144 and 1128 and 1148. Final totals are shown in block 1112 and 1132.

To ensure consistent color for maximum store shelf impact press conditions and variables must be controlled to be Repeatable, block 1150. The ability to measure and control Dot Gain and Density, block 1152, Print Register, block 1168 and Slurring, block 1174 is essential in meeting the customer's expectations. Dot Gain and Density must be consistent and controlled within a pressrun, block 1156, from Roll to Roll or from Skid to Skid, block 1160 and from Run to Run, block 1164. Point values awarded to these variables are shown in block 1158, 1162 and 1166, with the total point values in block 1154.

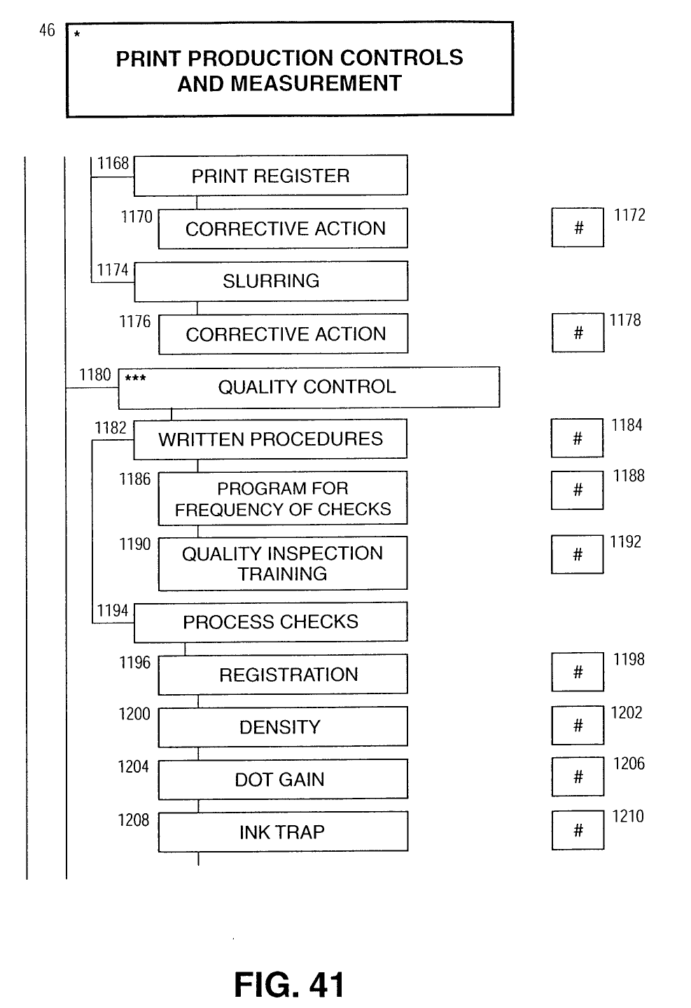

To print a clear and in focus image Print Register, FIG. 41, block 1168 must be held within tight tolerances. There must be a Corrective Action, block 1170 in place to correct register on press. No Slurring, block 1174 should be present. Slurring is the appearance of a printed image smeared in one direction. There must be a Corrective Action, block 1176 process for this defect. Point values are given to the corrective action measurement criteria and are shown in block 1172 and 1178.

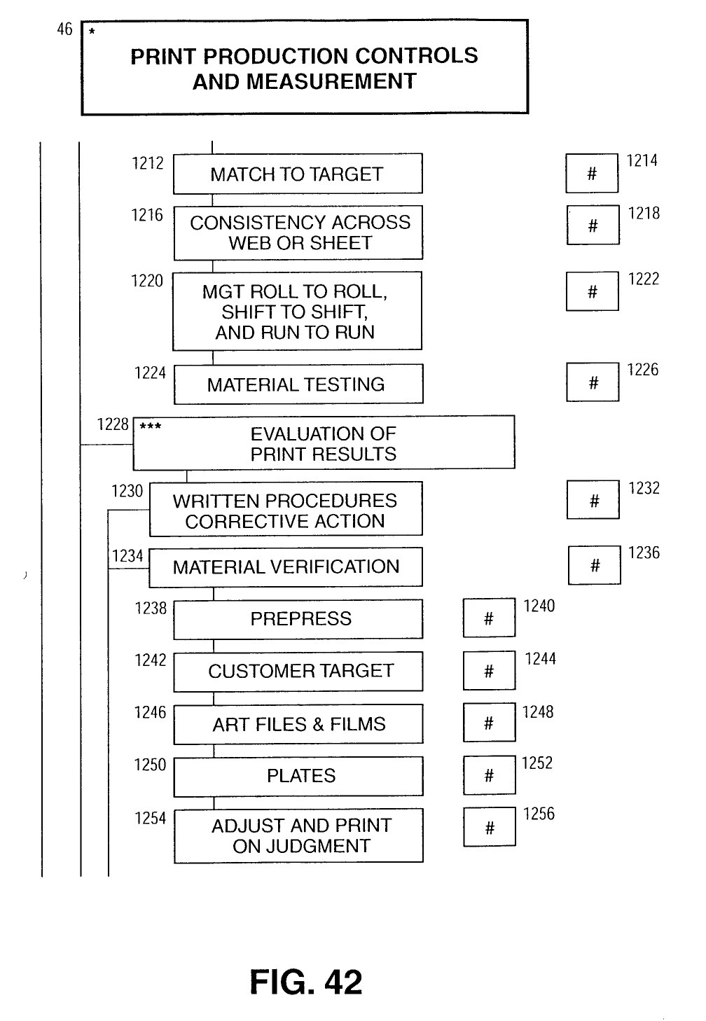

Quality Control, block 1180 must be in place throughout the process. These procedures must include a Program for the Frequency of Checks, block 1186. The monitoring of the press run must be conducted on a timely and consistent basis. There must be Written Procedures, block 1182 for all employees to follow. All employees must participate in Quality Inspection Training, block 1190 program. Some of the process checks, block 1194 may include Registration, block 1196, Density, block 1200, Dot Gain, block 1204, Ink Trap, block 1208, Match to Target, FIG. 42, block 1212, Consistency Across the Web or Sheet, block 1216, Management of the Printing from Roll to Roll, Shift to Shift and Run to Run, block 1220 and Material Testing, block 1224. The point values for these measurement criteria are noted in FIG. 41, block 1184, 1188, 1192,1198, 1202, 1206, 1210, FIG. 42, block 1214, 1218, 1222 and 1226.

After a pressrun is completed or aborted an Evaluation of Print Results, block 1228 must be completed. This is when the printed job or reject samples are reviewed to determine how to resolve and correct any printing problems or printing defects. This is a mandatory step when the density numbers and other readings are printed the same as what was printed on the characterization but the image does not match the target. There must be Written Procedures, block 1230 for this process. All the variables must be reviewed with a Material Verification, block 1234 that may include some of these variables: Prepress Materials, block 1238, Customer Target, block 1242, Art Files and Films and block 1246, Plates, block 1250. The point values for these variables are shown in block 1240, 1244, 1248, and 1252. If the image on press is Adjusted and Printed on Judgment, block 1254 the point values will be less block 1256. This will not provide the opportunity to correct the out of specification variables so the next printing can be run to specification. The total for the Evaluation of Print Results is shown in block 1232 and 1236.

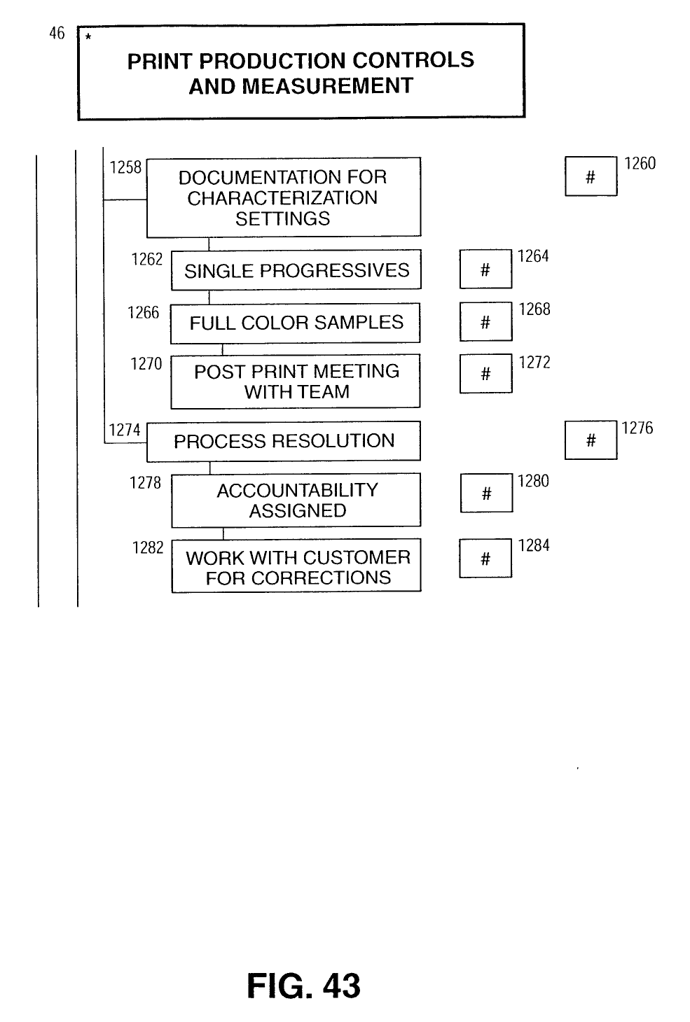

Another part of the evaluation of print results includes the Documentation for Character Settings, FIG. 43, block 1258 and Process Resolution block 1274. Press samples must be compared to the press characterization. The prepress materials were made from the data from the characterization. Print samples can be reviewed against the characterization to determine the problems. Some of these steps might include the review of Single Progressives, block 1262, single and multiple colors printed separately so as to review color by color, Full Color Samples block 1266, press samples with all colors printed and a Post Print Meeting with the Team block 1270. Each of these steps is an integral part of the process. Point values awarded to each of these are shown in block 1264, 1268 and 1272, with the total received in block 1260.

To accomplish process resolution, block 1274, Accountability must be Assigned, block 1278 and the printer and suppliers must Work with the Customer to make corrections block 1282. The point values for these steps are shown in block 1280 and 1284 with the total that can be achieved in block 1276.

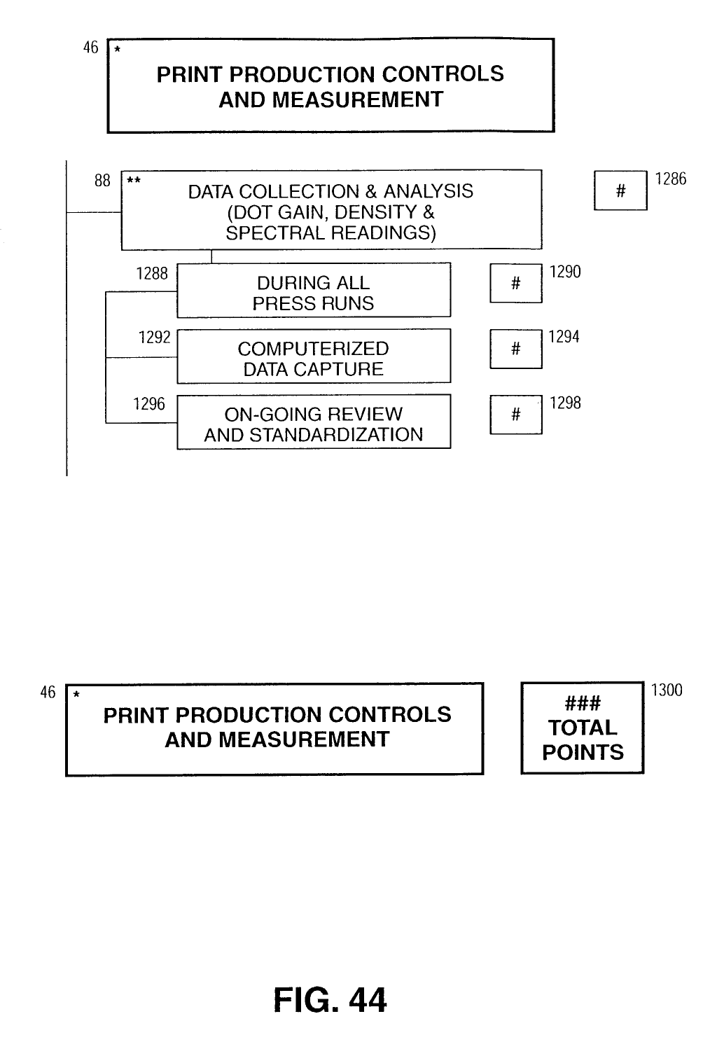

Data Collection and Analysis of such things as Dot Gain, Density and Spectral Readings FIG. 44, block 88 must be gathered and used to set standards, measure and review the process. Data must be collected During All Pressruns, block 1288. The best method of collecting data is by a Computerized Data Capture system, block 1292, which logs data directly from the press. To achieve consistent and repeatable results an On-Going Review and Standardization must be made, block 1296, so as to stabilize or improve the process. Point values for these elements are shown in block 1290, 1294 and 1298, with total point values shown in block 1286.

Block 1300 shows the total point values for Block 46, Print Production Controls and Measurement category.

### Pressroom Practices

In the Figures, measurement categories are preceded by a star, measurement subcategories are preceded by two stars, and measurement criteria are preceded by three stars.

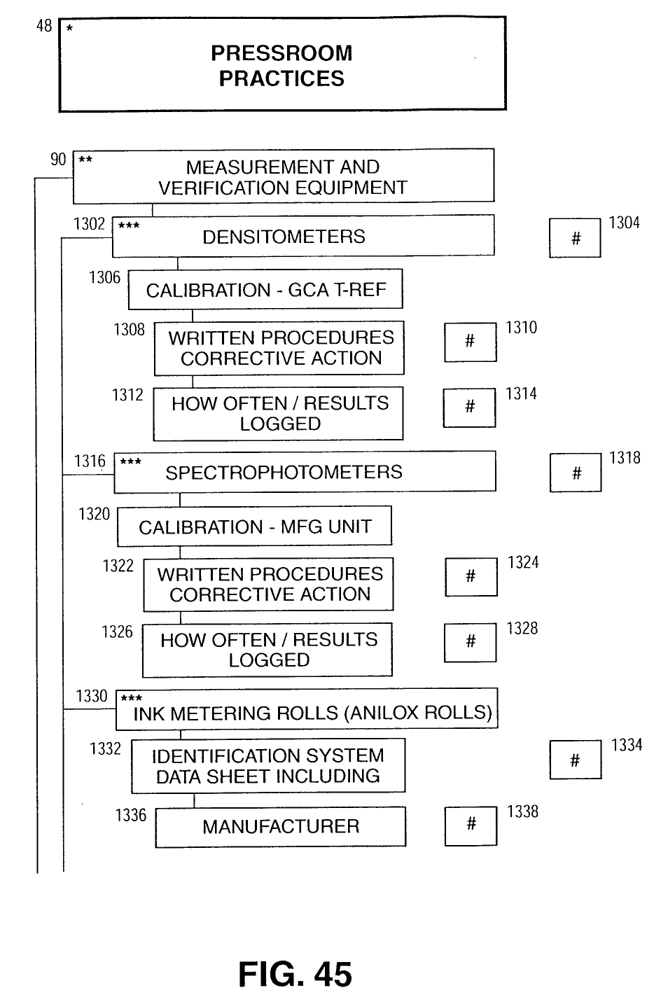

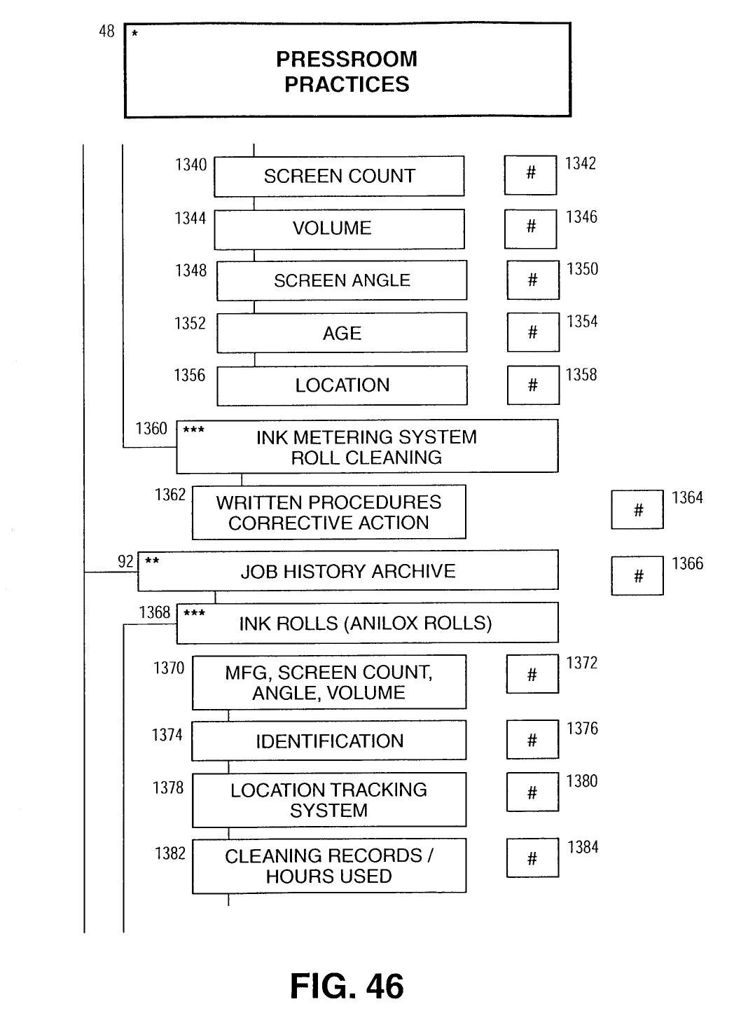

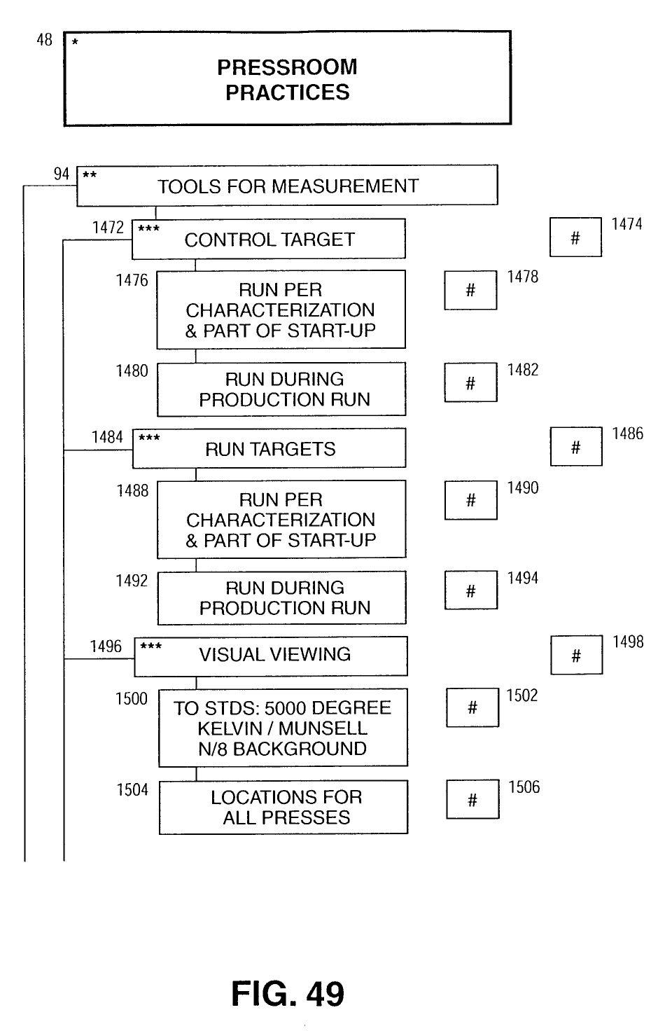

To ensure consistency in the pressroom procedures and equipment must be maintained. This category is explained in FIGS. 45, 46, 47, 48, 49, 50 and 51. The main subcategories are Measurement and Verification Equipment, FIG. 45, block 90, Job History Archive, FIG. 46, block 92 and Tools for Measurement, FIG. 49, block 94.

Measurement and Verification Equipment, FIG. 45, block 90 includes Densitometers, block 1302 a device that measures dot gain, density, grayness, hue error and ink trap of the four process colors. The unit must be calibrated to a standard such as GCA (Graphic Communications Association) T-Ref, block 1306, a tile or laminated block with white, black, magenta and cyan color patches with readings for each to be used as a calibration target. There must Written Procedures and a Corrective Action Process, block 1308 and the Results must be logged on a Consistent Basis, block 1312. The point values awarded for these segments are noted in block 1310 and 1314 with the total point values shown in block 1304. Another device used to measure is a Spectrophotometer, block 1316, a unit that measures color in terms of lightness, saturation and hue. The unit must Calibrated to the manufacturer's unit specifications block 1320. There must be Written Procedures and Corrective Action plan, block 1322 and the Results Logged on a consistent basis, block 1326. The point values awarded for these segments are noted in block 1324 and 1328 with the total point values shown in block 1318. Ink Metering Systems block 1330, (ink rollers for lithography, anilox rolls for flexography) are rolls or devices that meter or dispense the ink to the printing plate or transfer roll. An Identification System including a data sheet, block 1332 must be maintained to record such things as the Manufacturer, block 1336, Screen Count, FIG. 46, block 1340 (flexography only), Volume, block 1344 (flexography only), Screen Angle block 1348, Age, block 1352 and Location Stored block 1356. Point values awarded to these elements are noted in FIG. 45, block 1338, FIG. 46, block 1342, 1346, 1350, 1354 and 1358 with the total point values shown in FIG. 45, block 1334. The Ink Metering System, FIG. 46, block 1360 must be cleaned. The process must be documented and Written Procedures and a Corrective Action Process must be established block 1362. Point values for this measurement criteria is noted in block 1364.

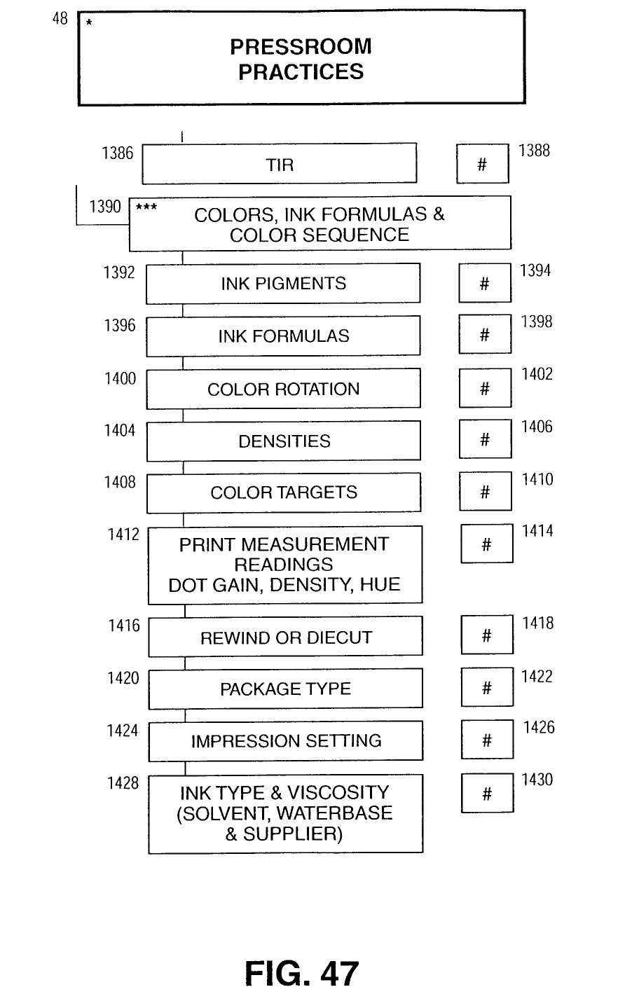

Job History Archive, block 92 must contain information such as, the Ink Rolls, block 1368 and Colors, Ink Formulas and Color Sequence used, FIG. 47, block 1390. Information to archive for the ink rolls are the Manufacturer, Screen Count, Angle and Volume of the Rolls, FIG. 46, block 1370, have some form of Identification, block 1374, have a Location Tracking System block 1378, a list when the rolls were cleaned and the hours used block 1382 and TIR (Total Indicated Runout) Measurements, FIG. 47, block 1386.

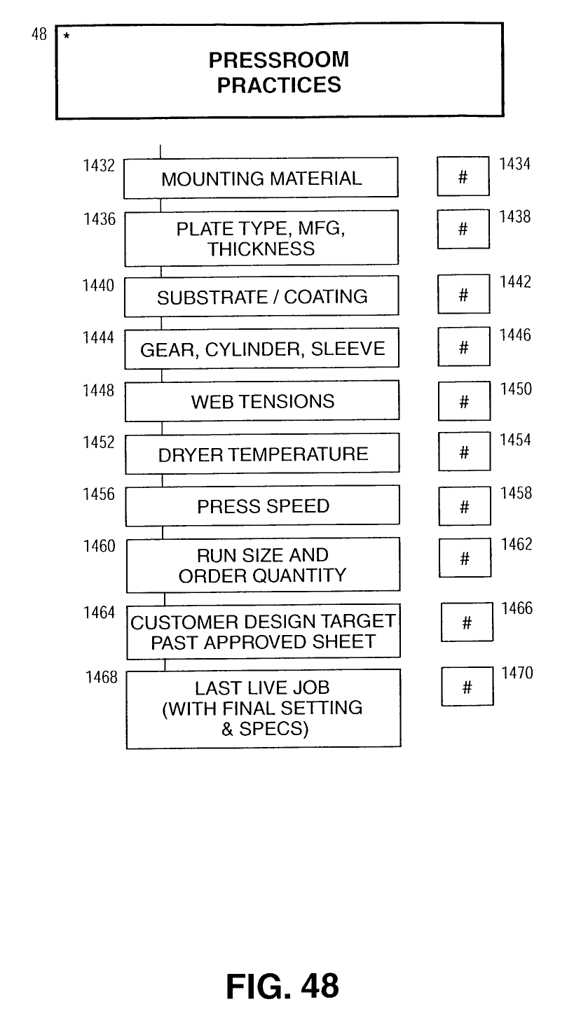

Colors, Ink Formulas and Color Sequence, block 1390 must also be recorded. Some of this information may include Ink Pigments, block 1392, the pigment number and manufacturer of the pigment, Ink Formulas, block 1396, the actual mixture of colors to make the ink color, Color Rotation, block 1400, the sequence or order the ink colors are printed, Densities, block 1404, the actual readings of the final approved sheet, Color Target, block 1408, the actual target art approved by the customer, Print Measurement Readings (dot gain, density, hue, etc.), block 1412, to use for subsequent runs, Rewind or Diecut, block 1416, the direction and orientation the printed substrate is would on the roll or the die cut shape and size that is used for cutting of cartons or labels, Package Type, block 1420, the type of package: a diecut carton, roll stock for bag making, premade bag, diecut label, etc., Impression Setting, block 1424, the amount of pressure applied to the plate or impression rolls, Ink Type and Viscosity, block 1428, the supplier of the ink and what ink system is used, Mounting Material, FIG. 48, block 1432, the material that adheres the plate to the plate cylinder, Plate Type, manufacturer and thickness (flexography), block 1436, Substrate and Coating, block 1440, stock to be printed and what coating, if any, is applied to the substrate, the Type of Gears, Cylinders, and Sleeves used on press, block 1444, Web Tensions, block 1448, the amount of stress applied to the web or sheet as it moves through the press, Dryer Temperature, block 1452, the heat applied to the substrate for drying purposes, Press Speed block 1456, Run Size and quantity, block 1460, Customer Design target and past approved sheet, block 1464, to review against subsequent runs and the Last Live Job with Final Settings and Specifications, block 1468, to ensure the same data is used for subsequent runs.

The point values awarded to Job History Archive are noted in FIG. 46, block 1372, 1376, 1380, 1384, FIG. 47, block 1388, 1394, 1398, 1402, 1406, 1410, 1414, 1418, 1422, 1426, 1430, 1434, FIG. 48, block 1438, 1442, 1446, 1450, 1454, 1458, 1462, 1466 and 1470 with a total point values shown in FIG. 46, block 1366.

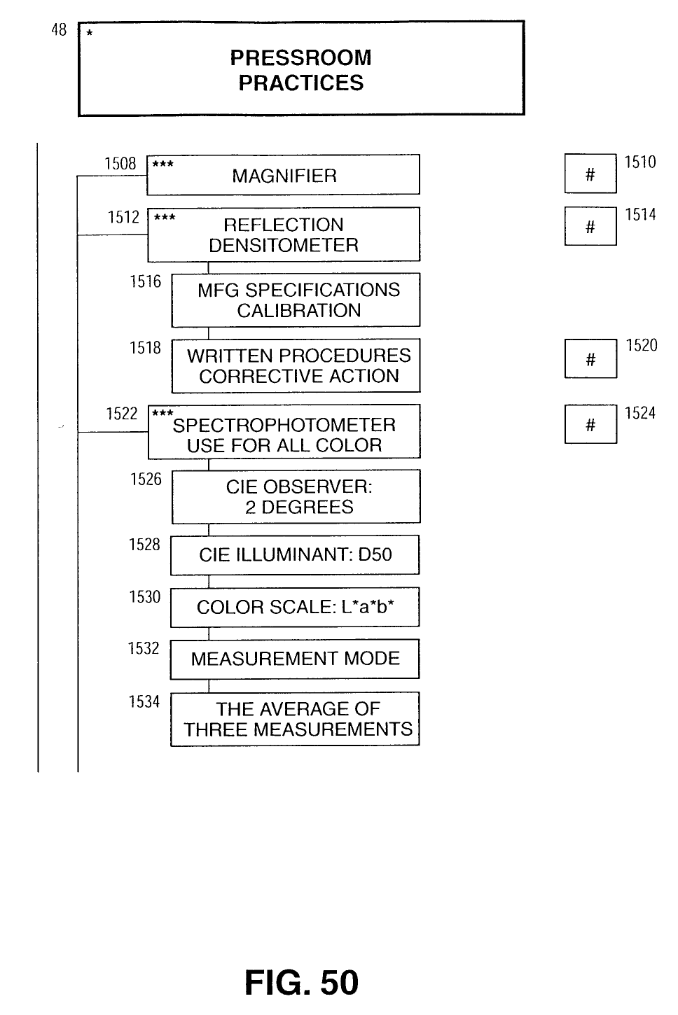

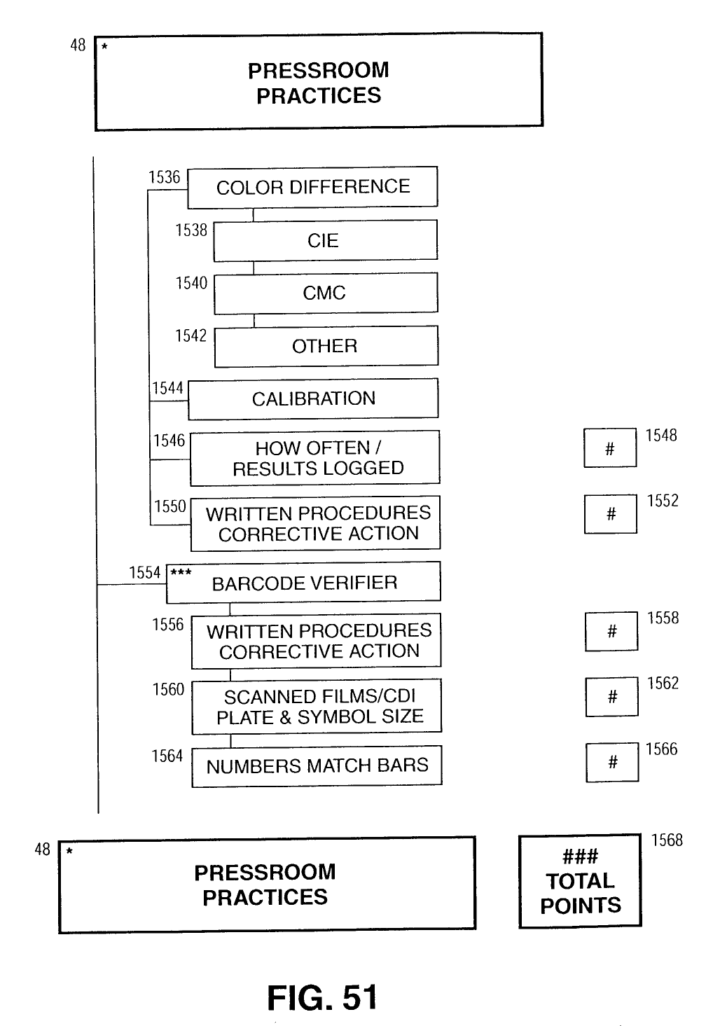

There are many Tools for Measurement, FIG. 49, block 94 that will test and monitor variables. Some of these include a Control Target, block 1472, Run Target, block 1484, Visual Viewing, block 1496, a Magnifier, FIG. 50, block 1508, a Reflection Densitometer, block 1512, a Spectrophotometer block 1522 and a Barcode Verifier, FIG. 51, block 1554. Control Targets, FIG. 49, block 1472 are patches of color of each of the inks. They can be measured for density, dot gain and ink color match. They must be Run Per the Characterization and must be part of the Start-Up, block 1476. By using these targets the run can be set to the same specifications as the characterization was run to. This will also prove the validity of the film separations that are made to the characterization. To ensure run consistency, Control Targets must be run During the Production Run, block 1480. Point values for these elements are listed in block 1478 and 1482 with total point values shown in block 1474.

Run Targets, block 1484 are usually parts of a Control Target so the appearance of the targets does not detract from the package design. These must also be Run Per the Characterization and be part of Start-Up, block 1488. To provide the best information and data of the variables these must be Run During the Production Run, block 1492. The point values for these measurement criteria are listed in block 1490 and 1494 with a total shown in block 1486.

Visual Viewing, block 1496 is also a method of viewing. It should not be done as a sole means of color evaluation. For consistency of viewing the light source must meet industry standard of 5000 Degree Kelvin with a Munsell (color system) N/8 Background color, block 1500. These light units must be at all color viewing stations and Located at Each Press, block 1504. The point values for visual viewing are listed in block 1502 and 1506 with the total shown in block 1498.

Another tool is a Magnifier, FIG. 50, block 1508. This is a magnifying glass to view printed variables, registration, dot gain, ink trap, etc. Point values for the use of the magnifier is shown in block 1510. The Reflection Densitometer, block 1512 is a unit that measures the optical density of colors and images of light with the use of filters for each of the process colors. The densitometer must be Calibrated to the manufacturer's specifications, block 1516 and there must be Written Procedures and Corrective Action for this process, block 1518. Point values for the use and care of the reflection densitometer is shown in block 1514 and Written Procedures and Corrective Action program point values are shown in block 1520.

A Spectrophotometer must be used to measure all color matches, block 1522. The spectrophotometer measures color in a three-dimensional color space, usually using L*a*b* values. The Lightness value (L*) indicates how light or dark a color is. The a* value indicates the position on the red-green axis and the b* is the position on the yellow-blue axis. A color target is read using the spectrophotometer and L*a*b* values are determined assigning the color in a specific point in color space.

The spectrophotometer should comply with industry specifications such as, CGATS 0.5-1993 Graphic Technology—Spectral Measurement and Colorimetric Computation for the Graphic Arts. The equipment must follow specifications for Observer, block 1526, the angle or range the sample is viewed CIE illuminant block 1528, the light source, the Color Scale, block 1530, the measurement system that will be used (L*a*b*, LCH, etc.), the Color Measurement Mode, block 1532, the measurement system that will be used (L*a*b*, LCH, etc.), using at average of three measurements, block 1534 to ensure repeatable results and measuring the color difference, FIG. 51, block 1536. Color Difference block 1536 is defined by using CIE, block 1538, CMC, block 1540 or another method block 1542 of color tolerancing.

Like all instruments the spectrophotometer must be Calibrated, block 1544 per the manufacturer's specifications. The results must be Logged with a Set Time Schedule must be in place, block 1546. Written Procedures and Corrective Action plans need to be in place to ensure the equipment is Calibrated to the same specifications, block 1550. The point values assigned to these variables are shown in FIG. 50, block 1524, FIG. 51, block 1548 and 1552.

To ensure the barcodes on packages are scannable a Barcode Verifier, block 1554 must be used. There must be Written Specification and a Corrective Action process in place, block 1556. The incoming materials that will create or produce the bar code, the Films or CDI (computer direct image) Plates must be Scanned and the symbol Size must be Verified, block 1560. The Human Readable Numbers must be Checked against the reading of the barcode block 1564. The total point values for these steps are noted in block 1558, 1562 and 1566.

Block 1568 shows the total point values for Block 48, Pressroom Practices.

### Press Assistance & Direction

In the Figures, measurement categories are preceded by a star, measurement subcategories are preceded by two stars, and measurement criteria are preceded by three stars.

In the Figures, measurement categories are preceded by a star, measurement subcategories are preceded by two stars, and measurement criteria are preceded by three stars.

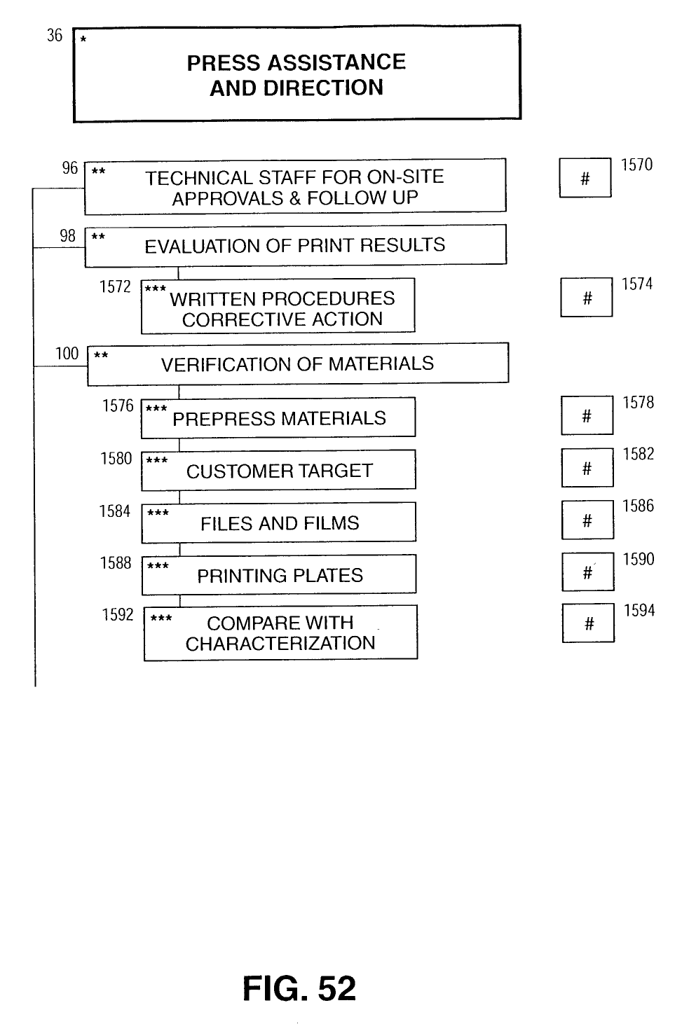

There must be Technical Staff On-Site, FIG. 52, block 96 to guide pressman through technical difficulties. They must help in the problem solving process not solve the problems themselves and be an advisor for the consumer product company representative who may be on-site for the approval of the press run.

There must be an Evaluation of Print Results, block 98 with Written Specifications and a Corrective Action plan in place, block 1572.

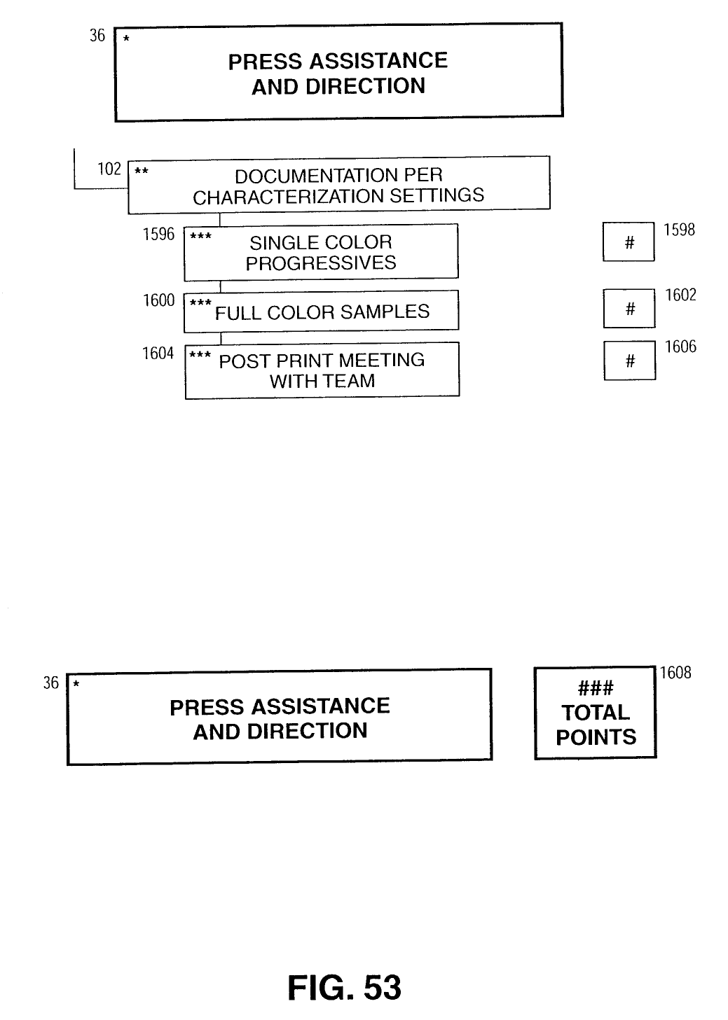

The technical staff is responsible for the Verification of Materials block, 100 which can include such elements as, Prepress Material, block 1576, film, proofs and plates, Customer Target, block 1580, the final artwork to match to, Files and Films, block 1584, art files, stripping files and films or data in the case of computer generated plates, Printing Plates, block 1588 and the Comparison of the Print Job with the Characterization, block 1592. The Documentation Per the Characterization Settings, FIG. 53, block 102 must be compared to the Single Progressives, block 1596 and the full color samples, block 1600 during a Post Print Meeting with the Team, block 1604. The point values for this segment are noted in FIG. 52, block 1570, 1574, 1578, 1582, 1586, 1590, 1594, FIG. 53, block 1598, 1602 and 1606 with the total for the Press Assistance and Direction category shown in block 1608.

### Technical Advancements, Innovations & On-Going R&D

In the Figures, measurement categories are preceded by a star, measurement subcategories are preceded by two stars, and measurement criteria are preceded by three stars.

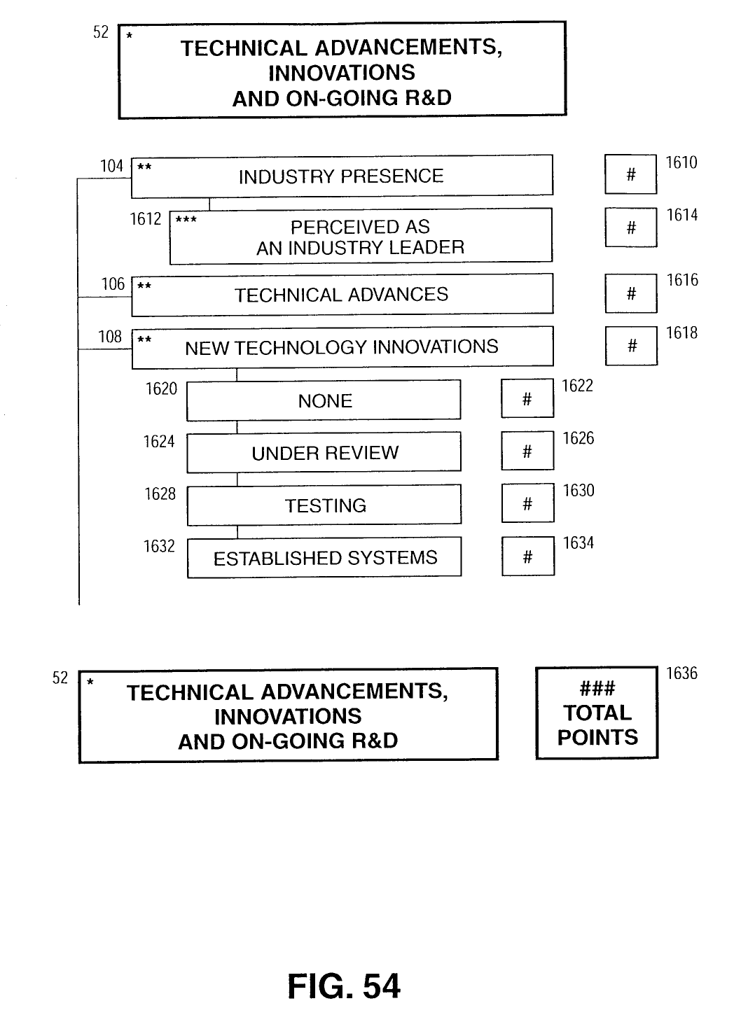

The Technical Advancements, Innovations and On-Going R&D category is described in FIG. 54. Industry associations can provide avenues for information about new technologies, as well as technical people on staff who are responsible for bringing innovation to the company. A company must have Industry Presence, block 104. With Industry Presence a company must be Perceived as an Industry Leader, block 1612 bringing new concepts to the industry using the New Technologies, block 106. The point values listed for these subcategories are listed in block 1610, 1614 and 1616.

To stay competitive printers must keep current with New Technical Innovations, block 108. Companies must be proactive in reviewing and testing new concepts and materials. The varying stages of the development is described as a company having No Interest or work towards innovation, block 1620, a company with new technologies Under Review block 1624, a company Testing new technologies, block 1628 and a company with Established Systems, block 1632. The point values are different for each level of innovation and are shown in block 1622, 1626, 1630 and 1634 with the total point values shown in block 1618.

Block 1636 shows the total point values for Block 52, Technical Advancements, Innovations & On-Going R&D.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. An auditing and certification method for printing operations, comprising the steps of:
defining a plurality of certification levels for a print operation, and a range of values for each certification level;
determining a plurality of measurement categories for selected printing processes which determine print process quality, with the measurement categories selected to indicate a level of quality of printing for a printing operation;
assigning numerical values to said measurement categories and summing said numerical values to arrive at a certification value; and
determining the certification level based on the certification value, the certification level indicating a level of quality of a printing operation.

2. The auditing and certification method of claim 1, which further includes the step of weighting of each category to the quality of a printing job or operation for a weighted numerical value.

3. The auditing and certification method of claim 1, which further includes the step of designating one or more certification levels as indicative of an unacceptable level of quality.

4. The auditing and certification method of claim 1, which further includes the step of determining a plurality of measurement subcategories relating to printing quality for each measurement category, with each measurement subcategory representing an aspect of quality of the measurement category under which it is placed, and assigning a potential numerical value to each measurement subcategory, so that the sum of the measurement subcategory potential values equals the potential value of the measurement category under which the measurement subcategories are placed;
totaling each of said subcategory numerical values for each category to arrive at a measurement category value for each category;
totaling each of said measurement category values to arrive at a certification value;
and assigning a certification level based on said certification value, the certification level indicating a level of quality that a printing operation will actually produce.

5. The auditing and certification method of claim 4, which further includes the steps of:
determining one or more measurement criteria for each measurement subcategory, with each measurement criteria representing a specific component of the aspect of printing quality of the measurement subcategory under which it is placed, and assigning a potential numerical value to each measurement criteria, so that the sum of the measurement criteria potential values equals the potential value of the measurement subcategory under which the measurement subcategories are placed;
defining quality conditions for each measurement criteria that equate to a range of numerical values;
evaluating a printer's capabilities by rating said printer's actual practices against each of said quality conditions to arrive at a condition numerical value for each quality condition;
totaling each of said condition numerical values to arrive at a measurement criteria value;
totaling each of said measurement criteria values for each measurement subcategories to arrive at a numerical value for each subcategory;
totaling each of said subcategory numerical values for each category to arrive at a measurement category value for each category;
totaling each of said measurement category values to arrive at a certification value; and
assigning a certification level based on said certification value, the certification level indicating a level of quality that a printing operation will actually produce.

6. The auditing and certification method of claim 5, which further includes the step of defining one or more measurement criteria which measures at least one production activity which is predictive of system output quality.

7. The auditing and certification method of claim 6, which further includes the step of defining one or more measurement criteria which measures at least one production activity which is predictive of system output quality for each measurement category.

8. The auditing and certification method of claim 1, which further includes the step of weighting which includes the step of adding a measurement category relating to communication, group dynamics, and management focus.

9. The auditing and certification method of claim 1, which includes the step of adding a measurement category relating to inspection practices for incoming materials.

10. The auditing and certification method of claim 1, which includes the step of adding a measurement category relating to print and press variables.

11. The auditing and certification method of claim 1, which includes the step of adding a measurement category relating to print preparation.

12. The auditing and certification method of claim 1, which includes the step of adding a measurement category relating to print production controls and measurement.

13. The auditing and certification method of claim 1, which includes the step of adding a measurement category relating to pressroom practices.

14. The auditing and certification method of claim 1, which includes the step of adding a measurement category relating to press assistance and direction.

15. The auditing and certification method of claim 1, which includes the step of adding a measurement category relating to technical advances and innovations.

16. The auditing and certification method of claim 8, which includes the step of evaluating the company mission, project team development and process, specifications and measurement, and standardized controls and measures as part of the measurement category relating to communication, group dynamics, and management focus.

17. The auditing and certification method of claim 9, which includes the step of evaluating materials of art, prepress, plates, barcodes and substrates as part of the in which the measurement categories include a category relating to inspection practices for incoming materials.

18. The auditing and certification method of claim 10, which includes the step of evaluating platemaking variables, platemounting variables, and ink management variables as part of the category relating to print and press variables.

19. The auditing and certification method of claim 11, which includes the step of evaluating press optimization, print optimization, and characterization as part of the category relating to print preparation.

20. The auditing and certification method of claim 12, which includes the step of evaluating procedure prior to press run, targets used for start-up and press runs, job history management, start-up procedure, and print run controls as part of the category relating to print production controls and measurement.

21. The auditing and certification method of claim 13, which includes the step of evaluating equipment used for measurement and verification, process and procedures for review and verification, and job history management and documentation, as part of the category relating to pressroom practices.

22. The auditing and certification method of claim 14, which includes the step of evaluating procedures in place for press start-up, technical staff on-site for press runs, and procedures for corrective action as part of the category relating to press assistance and direction.

23. The auditing and certification method of claim 15, which includes the step of evaluating industry presence and technical advances and innovations as part of the category relating to technical advances and innovations.

24. An auditing and certification method for printing operations, comprising the steps of:
defining a plurality of certification levels for a print operation, and a range of values for each certification level;
determining a plurality of measurement categories for selected printing processes which determine print process quality, with the measurement categories selected to indicate a level of quality of printing for a printing operation;
assigning numerical values to said measurement categories, based on the weighting of each category to the quality of a printing job or operation, and for summing to arrive at a certification value; and
determining a plurality of measurement subcategories relating to printing quality for each measurement category, with each measurement subcategory representing an aspect of quality of the measurement category under which it is placed, and assigning a potential numerical value to each measurement subcategory, so that the sum of the measurement subcategory potential values equals the potential value of the measurement category under which the measurement subcategories are placed;
determining one or more measurement criteria for each measurement subcategory, with each measurement criteria representing a specific component of the aspect of printing quality of the measurement subcategory under which it is placed, and assigning a potential numerical value to each measurement criteria, so that the sum of the measurement criteria potential values equals the potential value of the measurement subcategory under which the measurement subcategories are placed;
defining quality conditions for each measurement criteria that equate to a range of numerical values;
evaluating a printer's capabilities by rating said printer's actual practices against each of said quality conditions to arrive at a condition numerical value for each quality condition;
totaling each of said quality condition numerical values to arrive at a measurement criteria value;
totaling each of said measurement criteria values for each measurement subcategory to arrive at a numerical value for each subcategory;
totaling each of said subcategory numerical values for each category to arrive at a measurement category value for each category;
totaling each of said measurement category values to arrive at a certification value;
and assigning a certification level based on said certification value, the certification level indicating a level of quality that a printing operation will actually produce.

25. The auditing and certification method of claim 24, which further includes the step of weighting of each category to the quality of a printing job or operation for a weighted numerical value.

26. The auditing and certification method of claim 25, which further includes the step of designating one or more certification levels as indicative of an unacceptable level of quality.

27. The auditing and certification method of claim 24, which further includes the step of defining one or more measurement criteria which measures at least one production activity which is predictive of system output quality.

28. The auditing and certification method of claim 24, which further includes the step of defining one or more measurement criteria which measures at least one production activity which is predictive of system output quality for each measurement category.
